(19) United States
(12) Patent Application Publication
(10) Pub. No.: US 2026/0100799 A1
(43) Pub. Date: Apr. 9, 2026

(54) INDEPENDENT MAPPING OF COMMON AND PRIVATE TRANSPORT BLOCKS FOR RATE SPLITTING

(71) Applicant: QUALCOMM Incorporated, San Diego, CA (US)

(72) Inventors: Mostafa KHOSHNEVISAN, San Diego, CA (US); Xiaoxia ZHANG, San Diego, CA (US); Jing SUN, San Diego, CA (US); Chenxi HAO, Beijing (CN)

(21) Appl. No.: 19/115,206

(22) PCT Filed: Nov. 10, 2022
(86) PCT No.: PCT/CN2022/131011

§ 371 Date: Mar. 25, 2025

(51) Int. Cl. H04L 5/00; H04L 1/00

(52) U.S. Cl. CPC H04L 5/0053; H04L 1/0071

(57) ABSTRACT

Methods, systems, and devices for wireless communications are described. A network entity may perform rate splitting on a first message for a first user equipment (UE) and a second message for a second UE. The first message may include a first common portion and a first private portion and the second message may include a second common portion and a second private portion, where the rate splitting may include combining the first common portion and the second common portion to be a third common portion. The network entity may perform a first mapping operation to map the third common portion to one or more first physical resource blocks (PRBs) and perform a second mapping operation to map the first private portion to one or more second PRBs. The network entity may transmit the third common portion and the first private portion to the first UE via the first message.

### CROSS REFERENCE

This application is a 371 National Stage of PCT Application No. PCT/CN2022/131011, filed on Nov. 10, 2022, entitled “INDEPENDENT MAPPING OF COMMON AND PRIVATE TRANSPORT BLOCKS FOR RATE SPLITTING”, and assigned to the assignee hereof. The disclosure of the prior application is considered part of and is incorporated by reference into this patent application.

### FIELD OF TECHNOLOGY

The following relates to wireless communications, including independent mapping of common and private transport blocks for rate splitting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support independent mapping of common and private transport blocks for rate splitting. For example, the described techniques provide for efficient utilization of resources for rate splitting transmissions. In some examples, a network entity may perform rate splitting on a first message to a first user equipment (UE) and a second message for a second UE. In such examples, the network entity may split the first and second message into a first and second private portion and a common portion. The network entity may map the common portion to one or more first physical resource blocks (PRBs) and map the first private portion to one or more second PRBs. The network entity may transmit the common portion and first private portion to the first UE via the first message and mapping.

A method for wireless communication at a network entity is described. The method may include performing rate splitting on a first message for a first UE and a second message for a second UE, the first message including a first common portion and a first private portion, and the second message including a second common portion and a second private portion, the rate splitting including combining the first common portion and the second common portion into a third common portion, performing a first mapping operation to map the third common portion to one or more first PRBs for transmission, performing a second mapping operation that is independent of the first mapping operation, the second mapping operation to map the first private portion to one or more second PRBs for transmission, and transmitting, based on performing the first mapping operation and the second mapping operation and using the one or more first PRBs and the one or more second PRBs, the third common portion and the first private portion to the first UE via the first message.

An apparatus for wireless communication at a network entity is described. The apparatus may include a processor, memory coupled with the processor, and instructions stored in the memory. The instructions may be executable by the processor to cause the apparatus to perform rate splitting on a first message for a first UE and a second message for a second UE, the first message including a first common portion and a first private portion, and the second message including a second common portion and a second private portion, the rate splitting including combining the first common portion and the second common portion into a third common portion, perform a first mapping operation to map the third common portion to one or more first PRBs for transmission, perform a second mapping operation that is independent of the first mapping operation, the second mapping operation to map the first private portion to one or more second PRBs for transmission, and transmit, based on performing the first mapping operation and the second mapping operation and using the one or more first PRBs and the one or more second PRBs, the third common portion and the first private portion to the first UE via the first message.

Another apparatus for wireless communication at a network entity is described. The apparatus may include means for performing rate splitting on a first message for a first UE and a second message for a second UE, the first message including a first common portion and a first private portion, and the second message including a second common portion and a second private portion, the rate splitting including combining the first common portion and the second common portion into a third common portion, means for performing a first mapping operation to map the third common portion to one or more first PRBs for transmission, means for performing a second mapping operation that is independent of the first mapping operation, the second mapping operation to map the first private portion to one or more second PRBs for transmission, and means for transmitting, based on performing the first mapping operation and the second mapping operation and using the one or more first PRBs and the one or more second PRBs, the third common portion and the first private portion to the first UE via the first message.

A non-transitory computer-readable medium storing code for wireless communication at a network entity is described. The code may include instructions executable by a processor to perform rate splitting on a first message for a first UE and a second message for a second UE, the first message including a first common portion and a first private portion, and the second message including a second common portion and a second private portion, the rate splitting including combining the first common portion and the second common portion into a third common portion, perform a first mapping operation to map the third common portion to one or more first PRBs for transmission, perform a second mapping operation that is independent of the first mapping operation, the second mapping operation to map the first private portion to one or more second PRBs for transmission, and transmit, based on performing the first mapping operation and the second mapping operation and using the one or more first PRBs and the one or more second PRBs, the third common portion and the first private portion to the first UE via the first message.

Some examples of the method, apparatuses, and non-transitory computer-readable medium described herein may further include operations, features, means, or instructions for receiving, from the first UE, signaling indicating that the first UE may be capable of decoding a message including a first portion that may be mapped independently of a second portion, where performing the rate splitting on the first message and the second message may be based on receiving the signaling.

Some examples of the method, apparatuses, and non-transitory computer-readable medium described herein may further include operations, features, means, or instructions for receiving, from the first UE, signaling indicating whether the first UE may be capable of decoding a message including a first portion that may be mapped according to an interleaved mapping operation and a second portion that may be mapped according to a non-interleaved mapping operation, where performing the first mapping operation and the second mapping operation may be based on receiving the signaling from the UE.

Some examples of the method, apparatuses, and non-transitory computer-readable medium described herein may further include operations, features, means, or instructions for receiving, from the first UE, signaling indicating whether the first UE may be capable of decoding a message that may be mapped to a set of frequency resources by interleaving the message within PRBs that span the set of frequency resources, where the set of frequency resources may be allocated for the message and span a portion of a downlink bandwidth part, and where performing the first mapping operation and the second mapping operation may be based on receiving the signaling from the UE.

Some examples of the method, apparatuses, and non-transitory computer-readable medium described herein may further include operations, features, means, or instructions for performing the first mapping operation includes mapping the third common portion to the one or more first PRBs according to a non-interleaved mapping and performing the second mapping operation includes mapping the first private portion to the one or more second PRBs according to an interleaved mapping.

Some examples of the method, apparatuses, and non-transitory computer-readable medium described herein may further include operations, features, means, or instructions for transmitting, to the first UE, a control message including an indicator of a set of frequency resources for a transmission of the first message, where the one or more first PRBs and the one or more second PRBs each span the set of frequency resources, and where performing the first mapping operation and the second mapping operation may be based on transmitting the control message.

In some examples of the method, apparatuses, and non-transitory computer-readable medium described herein, the set of frequency resources span a portion of frequency resources within a downlink bandwidth part and performing the second mapping operation includes interleaving the first private portion within the set of frequency resources to map the first private portion to the one or more second PRBs.

Some examples of the method, apparatuses, and non-transitory computer-readable medium described herein may further include operations, features, means, or instructions for transmitting, to the second UE, a second control message including a second indicator of the set of frequency resources for a transmission of the second message, where the set of frequency resources span a downlink bandwidth part, and where performing the first mapping operation and the second mapping operation may be based on transmitting the second control message.

Some examples of the method, apparatuses, and non-transitory computer-readable medium described herein may further include operations, features, means, or instructions for transmitting, to the first UE, a control message including a first indication of whether the first mapping operation includes interleaving and a second indication of whether the second mapping operation includes interleaving, where performing the first mapping operation and the second mapping operation may be based on transmitting the control message.

Some examples of the method, apparatuses, and non-transitory computer-readable medium described herein may further include operations, features, means, or instructions for transmitting, to the first UE, signaling indicating that the control message includes the first indication and the second indication, where transmitting the control message may be based on transmitting the signaling.

Some examples of the method, apparatuses, and non-transitory computer-readable medium described herein may further include operations, features, means, or instructions for transmitting, to the first UE, signaling indicating that mapping operations performed on common portions of messages include non-interleaved mapping, transmitting, to the first UE and based on transmitting the signaling, a control message including an indication of whether the second mapping operation includes interleaving, where, performing the first mapping operation includes mapping the third common portion to the one or more first PRBs according to a non-interleaved mapping, and performing the second mapping operation includes mapping the first private portion according to a non-interleaved mapping or an interleaved mapping in accordance with the indication of whether the second mapping operation includes interleaving.

Some examples of the method, apparatuses, and non-transitory computer-readable medium described herein may further include operations, features, means, or instructions for performing the first mapping operation further includes mapping the third common portion to one or more first layers for transmission and performing the second mapping operation further includes mapping the first private portion to one or more second layers for transmission independently of mapping the third common portion to the one or more first layers for transmission.

In some examples of the method, apparatuses, and non-transitory computer-readable medium described herein, mapping, based on performing the first mapping operation and the second mapping operation, the third common portion and the first private portion of the first message to one or more antenna ports at the network entity, where transmitting the third common portion and the first private portion may be based on mapping the third common portion and the first private portion to the one or more antenna ports.

Some examples of the method, apparatuses, and non-transitory computer-readable medium described herein may further include operations, features, means, or instructions for performing a third mapping operation that may be independent of the first mapping operation and the second mapping operation, the third mapping operation to map the second private portion to one or more third PRBs for transmission and transmitting, based on performing the first mapping operation and the third mapping operation and using the one or more first PRBs and the one or more third PRBs, the third common portion and the second private portion to the second UE via the second message.

A method for wireless communication at a UE is described. The method may include receiving, from a network entity, a message including a common portion and a private portion, performing a first mapping operation to obtain the common portion based on a first mapping between one or more first PRBs and the common portion, and performing a second mapping operation that is independent of the first mapping operation, the second mapping operation to obtain the private portion based on a second mapping between one or more second PRBs and the private portion.

An apparatus for wireless communication at a UE is described. The apparatus may include a processor, memory coupled with the processor, and instructions stored in the memory. The instructions may be executable by the processor to cause the apparatus to receive, from a network entity, a message including a common portion and a private portion, perform a first mapping operation to obtain the common portion based on a first mapping between one or more first PRBs and the common portion, and perform a second mapping operation that is independent of the first mapping operation, the second mapping operation to obtain the private portion based on a second mapping between one or more second PRBs and the private portion.

Another apparatus for wireless communication at a UE is described. The apparatus may include means for receiving, from a network entity, a message including a common portion and a private portion, means for performing a first mapping operation to obtain the common portion based on a first mapping between one or more first PRBs and the common portion, and means for performing a second mapping operation that is independent of the first mapping operation, the second mapping operation to obtain the private portion based on a second mapping between one or more second PRBs and the private portion.

A non-transitory computer-readable medium storing code for wireless communication at a UE is described. The code may include instructions executable by a processor to receive, from a network entity, a message including a common portion and a private portion, perform a first mapping operation to obtain the common portion based on a first mapping between one or more first PRBs and the common portion, and perform a second mapping operation that is independent of the first mapping operation, the second mapping operation to obtain the private portion based on a second mapping between one or more second PRBs and the private portion.

Some examples of the method, apparatuses, and non-transitory computer-readable medium described herein may further include operations, features, means, or instructions for transmitting, to the network entity, signaling indicating that the UE may be capable of decoding a second message including a first portion that may be mapped independently of a second portion, where receiving the message may be based on transmitting the signaling.

Some examples of the method, apparatuses, and non-transitory computer-readable medium described herein may further include operations, features, means, or instructions for transmitting, to the network entity, signaling indicating whether the UE may be capable of decoding a second message including a first portion that may be mapped according to an interleaved mapping operation and a second portion that may be mapped according to a non-interleaved mapping operation, where receiving the message may be based on transmitting the signaling.

Some examples of the method, apparatuses, and non-transitory computer-readable medium described herein may further include operations, features, means, or instructions for transmitting, to the network entity, signaling indicating whether the UE may be capable of decoding a second message that may be mapped to a set of frequency resources by interleaving the second message within PRBs that span the set of frequency resources, where the set of frequency resources may be allocated for the second message and span a portion of a downlink bandwidth part, and where receiving the message may be based on transmitting the signaling.

In some examples of the method, apparatuses, and non-transitory computer-readable medium described herein, the first mapping includes a non-interleaved mapping of the common portion to the one or more first PRBs and the second mapping includes an interleaved mapping of the private portion to the one or more second PRBs.

Some examples of the method, apparatuses, and non-transitory computer-readable medium described herein may further include operations, features, means, or instructions for receiving, from the network entity, a control message including an indicator of a set of frequency resources for the message, where the one or more first PRBs and the one or more second PRBs each span the set of frequency resources, and where performing the first mapping operation and the second mapping operation may be based on receiving the control message.

In some examples of the method, apparatuses, and non-transitory computer-readable medium described herein, the set of frequency resources span a portion of frequency resources within a downlink bandwidth part and the second mapping includes an interleaved mapping within the set of frequency resources of the private portion to the one or more second PRBs.

Some examples of the method, apparatuses, and non-transitory computer-readable medium described herein may further include operations, features, means, or instructions for receiving, from the network entity, a control message including a first indication of whether the first mapping includes interleaving and a second indication of whether the second mapping includes interleaving, where performing the first mapping operation and the second mapping operation may be based on receiving the control message.

Some examples of the method, apparatuses, and non-transitory computer-readable medium described herein may further include operations, features, means, or instructions for receiving, from the network entity, signaling indicating that the control message includes the first indication and the second indication, where receiving the control message may be based on receiving the signaling.

Some examples of the method, apparatuses, and non-transitory computer-readable medium described herein may further include operations, features, means, or instructions for receiving, from the network entity, signaling indicating that mapping operations performed on common portions of messages include non-interleaved mapping, receiving, from the network entity and based on receiving the signaling, a control message including an indication of whether the second mapping includes interleaving, where, the first mapping includes a non-interleaved mapping of the common portion to the one or more first PRBs, and the second mapping includes a non-interleaved mapping or an interleaved mapping in accordance with the indication of whether the second mapping operation includes interleaving.

In some examples of the method, apparatuses, and non-transitory computer-readable medium described herein, the first mapping operation may be further based on a third mapping between one or more first layers and the common portion and the second mapping operation may be further based on a fourth mapping that may be independent of the third mapping, the fourth mapping between one or more second layers and the private portion.

In some examples of the method, apparatuses, and non-transitory computer-readable medium described herein, mapping, based on receiving the message, the message from one or more antenna ports at the UE, where performing the first mapping operation and the second mapping operation may be based on mapping the message from the one or more antenna ports.

### BRIEF DESCRIPTION OF THE DRAWINGS

FIGS. 1 through 3 illustrate examples of wireless communications systems that supports independent mapping of common and private transport blocks for rate splitting in accordance with one or more aspects of the present disclosure.

FIG. 4 illustrates an example of a transmission diagram that supports independent mapping of common and private transport blocks for rate splitting in accordance with one or more aspects of the present disclosure.

FIG. 5 illustrates an example of a resource mapping diagram that supports independent mapping of common and private transport blocks for rate splitting in accordance with one or more aspects of the present disclosure.

FIG. 6 illustrates an example of a process flow that supports independent mapping of common and private transport blocks for rate splitting in accordance with one or more aspects of the present disclosure.

FIGS. 7 and 8 illustrate block diagrams of devices that support independent mapping of common and private transport blocks for rate splitting in accordance with one or more aspects of the present disclosure.

FIG. 9 illustrates a block diagram of a communications manager that supports independent mapping of common and private transport blocks for rate splitting in accordance with one or more aspects of the present disclosure.

FIG. 10 illustrates a diagram of a system including a device that supports independent mapping of common and private transport blocks for rate splitting in accordance with one or more aspects of the present disclosure.

FIGS. 11 and 12 illustrate block diagrams of devices that support independent mapping of common and private transport blocks for rate splitting in accordance with one or more aspects of the present disclosure.

FIG. 13 illustrates a block diagram of a communications manager that supports independent mapping of common and private transport blocks for rate splitting in accordance with one or more aspects of the present disclosure.

FIG. 14 illustrates a diagram of a system including a device that supports independent mapping of common and private transport blocks for rate splitting in accordance with one or more aspects of the present disclosure.

FIGS. 15 through 18 illustrate flowcharts showing methods that support independent mapping of common and private transport blocks for rate splitting in accordance with one or more aspects of the present disclosure.

### DETAILED DESCRIPTION

Some wireless communications systems may support rate splitting techniques to increase capacity and reduce latency in a wireless communications system. For example, a network entity may communicate with a first user equipment (UE) and a second UE using rate splitting techniques. To perform rate splitting, the network entity may split a downlink message for the first UE and a downlink message for the second UE into a common portion of the respective messages (e.g., a common part between the two downlink messages for the first UE and the second UE) and private portions of the respective messages (e.g., two different messages associated with the first UE and the second UE). The network entity may encode and transmit the common portion to the first UE and the second UE, while each private portion may be separately encoded and transmitted to each UE. Each UE may decode the common portion, and based on the decoded common portion, decode the private portion to obtain the message. In this way, the UEs may obtain the downlink message based on decoding the common and private portion of the message.

In some wireless communications systems, the network entity may allocate resources to transmit the common portion and private portions to each UE according to an interleaved virtual resource block (VRB) to physical resource block (PRB) mapping within a bandwidth part. However, if the first UE and the second UE have different physical bandwidth parts, the mapping from VRBs-to-PRBs may differ between the first UE and the second UE, which may prohibit both the first and second UEs from receiving the common portion of the messages via the same set of PRBs. For example, the network entity may allocate VRBs for each UE that correspond to the same VRB locations (e.g., frequency VRB location) within the bandwidth parts of each UE respectively. However, due to differing bandwidth parts at each UE, the function to interleave the VRBs to PRBs may be different, causing different physical resource allocation for the common and private portions of the messages at each UE. Further, in some examples, the first UE may support resource allocation according to a VRB-to-PRB interleaved mapping, while the second UE may not support such resource allocation techniques (e.g., may not support VRB-to-PRB interleaved mapping). In such examples, both the common and private portions of the message may be mapped without interleaving (e.g., to accommodate the second UE's inability to support interleaved mapping), which may decrease a reliability of the message at the first UE (e.g., as compared to cases where the common and private portions of the message to the first UE are interleaved, which improves a reliability of communications).

The techniques described herein may enable the network entity to efficiently map resources for rate splitting. In one example, the network entity may map the common portion and private portions of the messages to layers and resources independently, which may allow separate VRB-to-PRB mapping for the private and common portions of the messages. In such examples, resource mapping for either the common portion or private portion of the messages may be done with or without VRB-to-PRB interleaving. Additionally, the network entity may perform VRB-to-PRB mapping according to an interleaving operation within the allocated PRBs (e.g., rather than across the entire bandwidth). In some examples, the network entity may configure the same bandwidth part across each UE, such that interleaving between the VRBs and PRBs may be the same between each UE.

The network entity may transmit control signaling indicating whether the private and common portions of the messages are interleaved or non-interleaved within the allocated resources (e.g., within the allocated PRBs). In some other examples, the network entity may operate under a fixed assumption where the common portion of the message is interleaved when rate splitting is used. In some examples, each UE may transmit a capability message to the network entity indicating whether the UEs support rate splitting, VRB-to-PRB mapping, separately mapping common and private portions to different layers and resources, among other capabilities. In such examples, the network entity may transmit the common and private portions to each UE according to the indicated UE capabilities.

Aspects of the disclosure are initially described in the context of wireless communications systems. Aspects of the disclosure are described in the context of resource mapping configurations and process flows. Aspects of the disclosure are further illustrated by and described with reference to apparatus diagrams, system diagrams, and flowcharts that relate to independent mapping of common and private transport blocks for rate splitting.

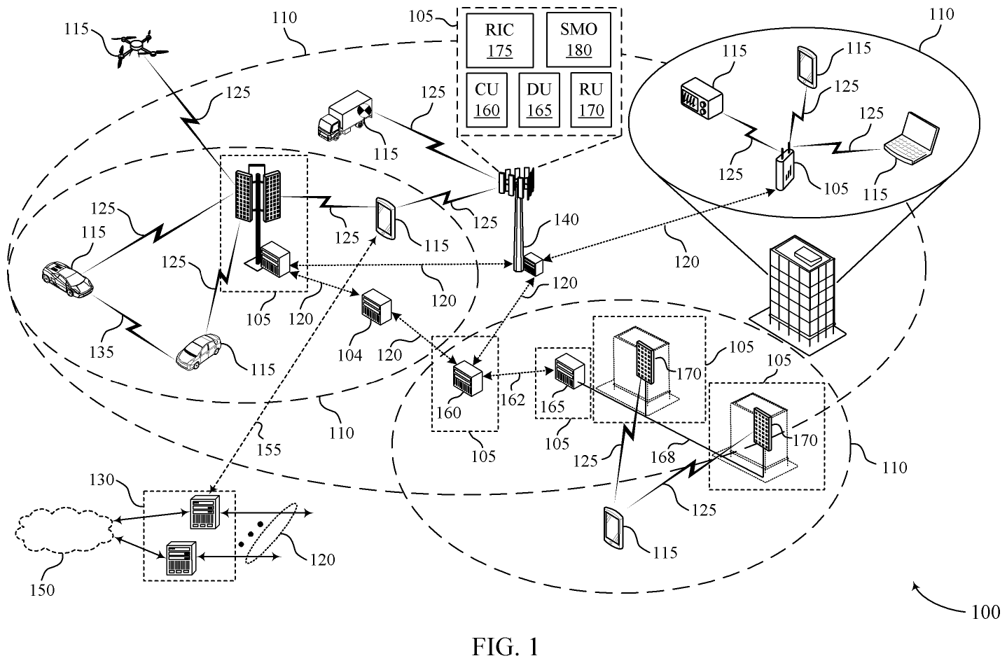

FIG. 1 illustrates an example of a wireless communications system 100 that supports independent mapping of common and private transport blocks for rate splitting in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support independent mapping of common and private transport blocks for rate splitting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, the wireless communications system 100 may support rate splitting techniques to increase capacity and reduce a quantity of transmissions made by the network entity 105. For example, the network entity 105 may communicate with a first UE 115 and a second UE 115 using splitting techniques. Specifically, the network entity 105 may split a downlink message for the first UE 115 and a downlink message for the second UE 115 into a common portion of the respective messages (e.g., a portion of the respective messages that is common between the two downlink messages for the first UE 115 and the second UE 115) and private portions of the respective messages (e.g., two different messages associated with the first UE 115 and the second UE 115). The network entity may encode and transmit the common portion to the first UE 115 and the second UE 115, while each private portion may be separately encoded and transmitted to each UE 115. Each UE 115 may decode the common portion to identify the private portions of the messages intended for the respective UE 115 and identify information associated with decoding the private portion. In this way, the UEs 115 may obtain the downlink message based on decoding the common and private portion of the message.

Additionally, the network entity 105 may allocate resources to transmit the common portion and private portions to each UE 115 according to an interleaved VRB-to-PRB mapping within a bandwidth part. However, if the first UE 115 and the second UE 115 have different physical bandwidth parts, the mapping from VRBs to PRBs may differ between the first UE 115 and the second UE 115, which may prohibit both the first and second UEs 115 from receiving the common portion via the same set of PRBs. For example, the network entity 105 may allocate VRBs for each UE 115 that correspond to the same VRB locations (e.g., frequency VRB location) within the bandwidth parts of each UE 115 respectively. However, due to differing bandwidth parts at each UE 115, the function to interleave the VRBs to PRBs may be different, causing different physical resource allocation for the common and private portions of the messages at each UE 115. Further, in some examples, the first UE 115 may support resource allocation according to a VRB-to-PRB interleaved mapping, while the second UE 115 may not support such resource allocation techniques (e.g., may not support VRB-to-PRB interleaved mapping). In such examples, both the common and private portions of the message may be mapped without interleaving (e.g., to accommodate inability of the second UE 115 to support interleaved mapping), which may decrease a reliability of the message at the first UE 115 (e.g., as compared to cases where the common and private portions of the message to the first UE are interleaved, which improves a reliability of communications).

In some implementations, the network entity 105 may independently map the common portion and private portions of the messages to layers and resources, which may allow separate VRB-to-PRB mapping for the private and common portions of the messages. In such examples, resource mapping for either the common portion or private portion of the messages may be done with or without VRB-to-PRB interleaving. Additionally, the network entity 105 may interleave the VRB-to-PRB by interleaving within the allocated PRBs (e.g., rather than across the entire bandwidth). In some examples, the network entity 105 may configure the same bandwidth part across each UE 115, such that interleaving between the VRBs and PRBs may be the same between each UE 115.

For example, the network entity 105 may perform rate splitting on a first message for the first UE 115 and a second message for the second UE 115. In such examples, the network entity may split the first message into a first common portion and a first private portion and split the second message into a second common portion and a second private portion. Further, the network entity may combine the first common portion and the second common portion into a third common portion. Based on performing the rate splitting, the network entity may perform a first mapping operation to map the third common portion to one or more PRBs for transmission and perform a second mapping operation, that is independent of the first mapping operation, to map the first private portion to one or more second PRBS. The network entity may transmit the third common portion and the first private portion to the first UE 115 in accordance with the first and second mapping operations.

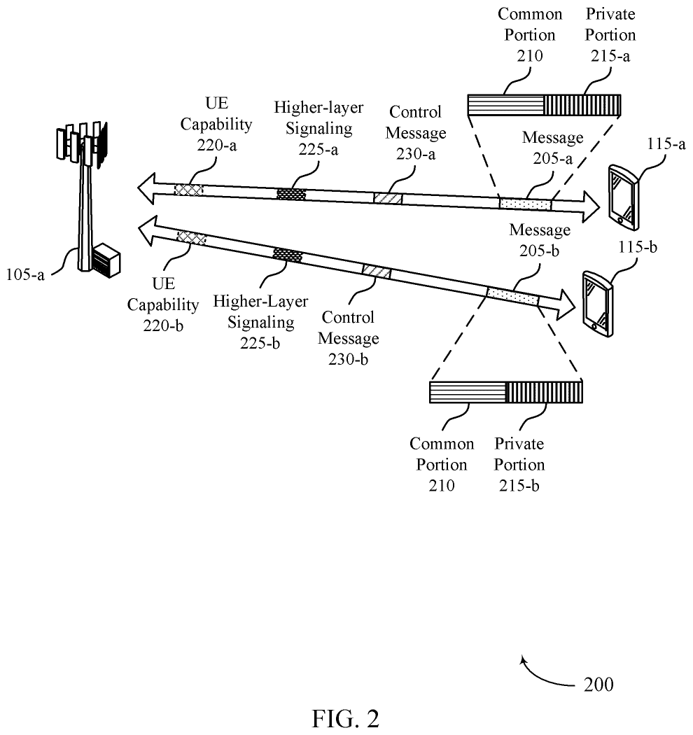

FIG. 2 illustrates an example of a wireless communications system 200 that supports independent mapping of common and private transport blocks for rate splitting in accordance with one or more aspects of the present disclosure. The wireless communications system 200 may implement, or be implemented by, aspects of the wireless communications system 100, as described herein with reference to FIG. 1. For example, the wireless communications system 200 may include a network entity 105-a, a UE 115-a, and a UE 115-b, which may be examples of a network entity 105 and a UE 115 described with reference to FIG. 1.

In some cases of the wireless communications system 200, the network entity 105-a may communicate a message 205-a and a message 205-b with the UE 115-a and the UE 115-b, respectively, via rate splitting techniques. In such examples, the network entity 105-a may split the messages 205 into a common portion 210 and private portions 215. That is, the network entity may split the message 205-a into a common portion 210 and a private portion 215-a and split the message 205-b into the common portion 210 and a private portion 215-b. In some cases, the network entity may allocate resources to transmit the common portion 210 and the private portions 215 according to a VRB-to-PRB interleaved mapping within bandwidth parts associated with each UE 115.

For example, the network entity may allocate the same VRB locations (e.g., same frequency locations in the VRB domain) within the respective bandwidth parts of each UE 115 for the transmission of the common portion 210 and the private portions 215. In such cases, the network entity may map both the common portion 210 and private portion 215-a to PRBs in the bandwidth part of the UE 115-a together, according to a VRB-to-PRB interleaving function. Likewise, the network entity may map both the common portion 210 and private portion 215-b to PRBs in the bandwidth part of the UE 115-b together, according to the VRB-to-PRB interleaving function. The network entity may transmit the message 205-a and the message 205-b via the PRBs to the UE 115-a and the UE 115-b, respectively. Each UE 115 may receive the respective messages 205 and decode the common portion 210. Based on decoding the common portion 210, the UEs 115 may decode the private portions 215.

In some cases, however, if the UE 115-a and the UE 115-b have different physical bandwidth parts (e.g., the UE 115-a has less or more PRBs in the bandwidth part than the UE 115-b), the mapping from the allocated VRBs (e.g., which have the same locations in the VRB domain between UEs 115) to the PRBs (e.g., in the physical bandwidth parts of each UE 115) may differ between the UE 115-a and the UE 115-b. In such cases, the difference in VRB-to-PRB mapping between the UE 115-a and the UE 115-b may prohibit both the UE 115-a and the UE 115-b from receiving the common portion 210 of the messages 205 via the same set of PRBs, thereby prohibiting the UEs 115 from decoding the private portions 215 of the messages 205.

Further, in some cases, the UE 115-a may support resource allocation according to a VRB-to-PRB interleaved mapping, while the UE 115-b may not support such resource allocation techniques. In such cases, both the common portion 210 and private portions 215 of the messages 205 may be mapped without interleaving (e.g., to accommodate the inability of the UE 115-b to support interleaved mapping), which may decrease a reliability of the message 205-a at the UE 115-a (e.g., as compared to cases where the common portion 210 and private portion 215-a of the message 205-a to the UE 115-a are interleaved, which improves a reliability of communications).

In some implementations of the wireless communications system 200, the network entity 105-a may independently map the common portion 210 and private portions 215 of the messages 205 to layers and resources. In some implementations, the network entity 105-a may map the common portion 210 via a non-interleaved operation, while mapping the private portions 215 via an interleaved operation. In such implementations, the network entity 105-a may interleave the VRBs with the PRBs according to the allocated PRBs for each UE 115 (e.g., rather than across the entire bandwidth of each UE 115), thereby reducing the likelihood of separate VRB-to-PRB mappings for the common portion 210 of the messages 205. Additionally, or alternatively, the network entity 105-a may allocate the same physical bandwidth part size for the UE 115-a and the UE 115-b, such that VRB-to-PRB mapping for the common portion 210 of the message 205-a and the message 205-b are the same.

In the example of the wireless communications system 200, the UE 115-a and the UE 115-b may transmit a UE capability message 220-a and a UE capability message 220-b, respectively, to the network entity 105-a. The capability messages may indicate one or more capabilities of the UEs 115. For example, the UEs 115 may indicate, via the UE capability messages 220, a capability of the UEs 115 to independently map the common portion 210 and the private portions 215 of the messages 205. That is, the UEs 115 may indicate whether the UEs 115 are capable of separate layer and resource mapping for the common portion 210 and the private portions 215. In some examples, the UEs 115 may indicate, via the UE capability messages 220, a capability of the UEs 115 to decode the messages 205, where the common portion 210 is mapped according to non-interleaved operation and the private portions 215 are interleaved according to a VRB-to-PRB mapping function. In such examples, the UEs 115 may indicate, via the UE capability messages 220, a capability to perform VRB-to-PRB interleaving with respect to the PRB (e.g., rather than with respect to the entire physical bandwidth part of the UEs). Additionally, or alternatively, the UEs 115 may indicate a capability to support rate splitting in the wireless communications system (e.g., the ability to decode the common portion 210 and the private portions 215 in a physical downlink shared channel (PDSCH)).

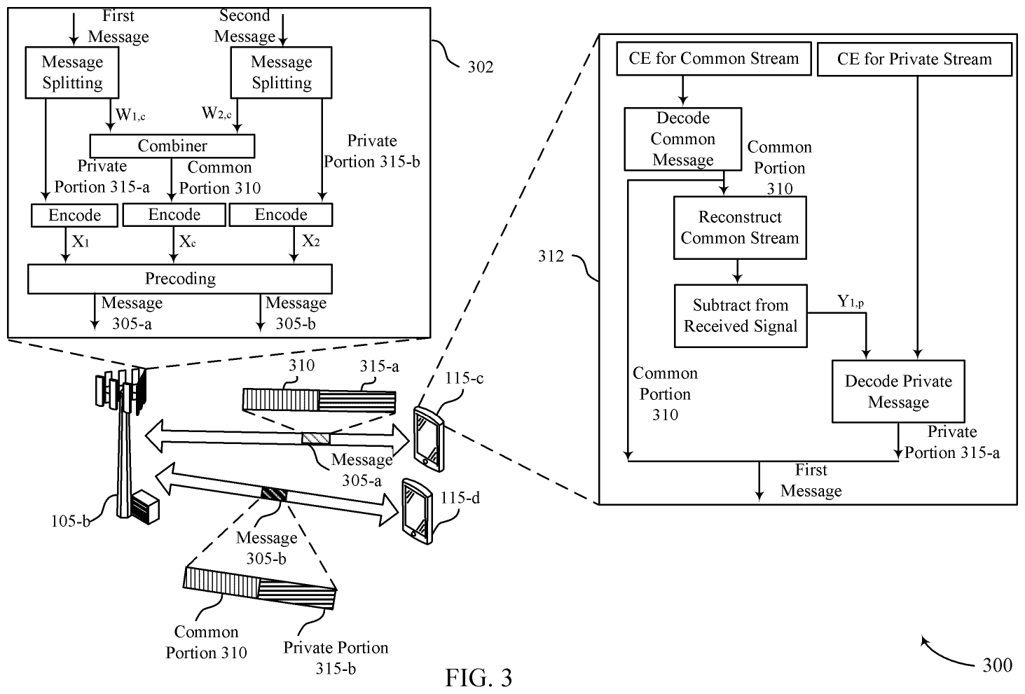

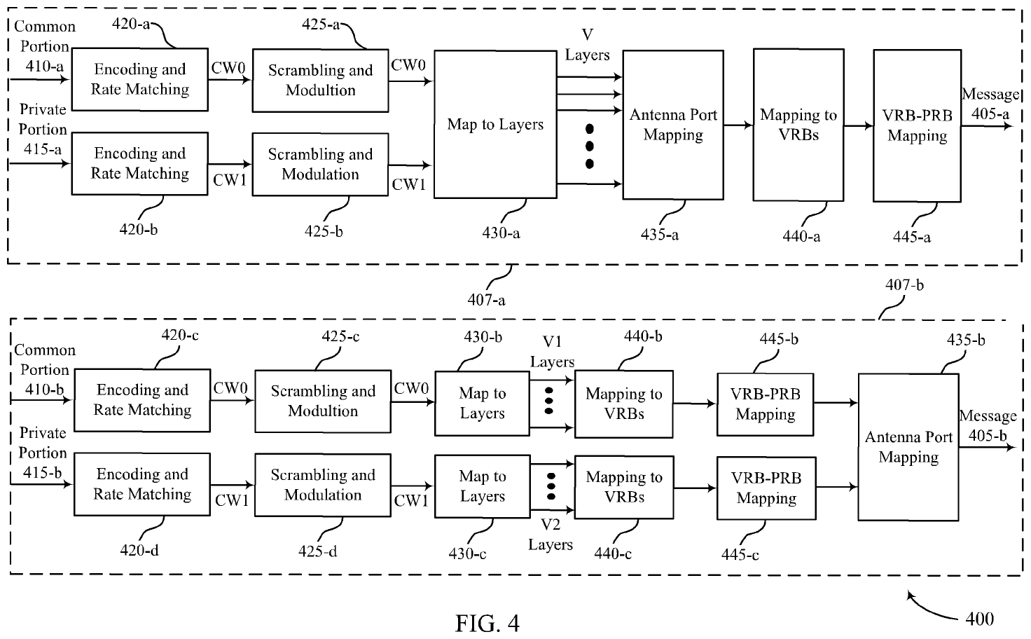

The network entity may perform the rate splitting operations based on the received UE capability messages 220. For example, if the UEs 115 indicate a capability to support rate splitting, the network entity 105-a may perform communications with the UE 115-a and the UE 115-b using rate splitting techniques further described herein with reference to FIG. 3. In some examples, if the UEs 115 indicate a capability to independently map the common portion 210 and the private portions 215 of the messages 205, the network entity may perform the independent resource mapping according to techniques further described herein with reference to FIG. 4 and transmit the messages 205 to the UEs 115.

In some examples, if the UEs 115 indicate a capability to decode the messages 205, where a first portion of the messages 205 is mapped according to a non-interleaved operation and another portion of the messages 205 is interleaved according to an interleaved operation, the network entity may transmit higher-layer signaling 225-a and higher-layer signaling 225-b (e.g., such as RRC signaling) indicating that the control messages 230 (e.g., control message 230-a and control message 230-b) may include an indication of which portion (e.g., the common portion 210 or the private portions 215) of the messages 205 are mapped according to the non-interleaved mapping or according to the interleaved operation. Accordingly, the network entity 105-a may transmit the control message 230-a that indicates whether the common portion 210 and the private portion 215-a are mapped according to a non-interleaved operation in accordance with the indication of the higher-layer signaling 225-a.

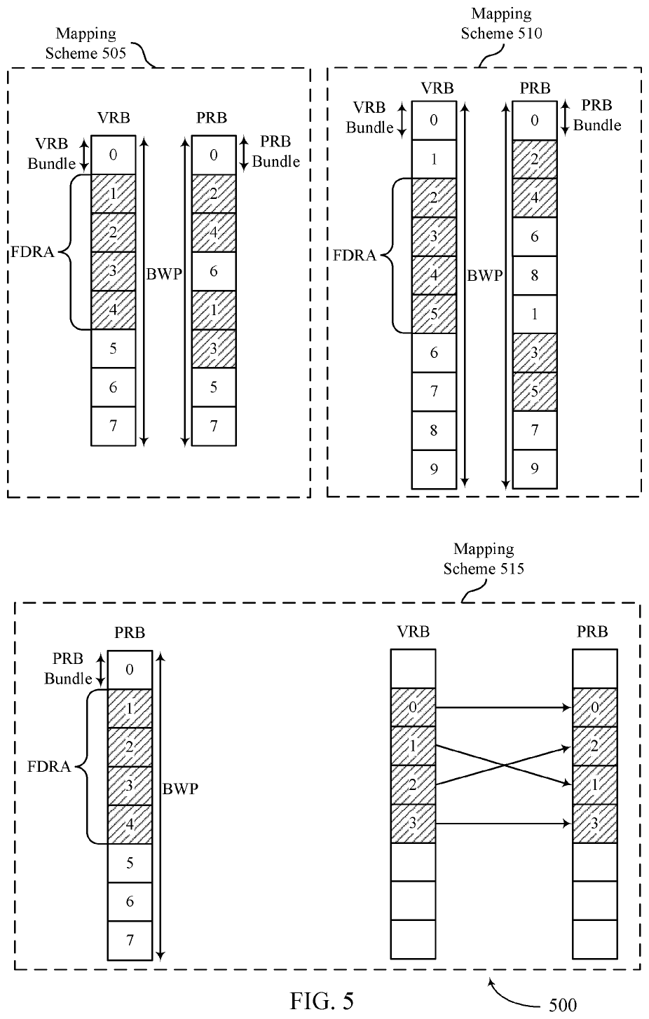

Additionally, or alternatively, the higher-layer signaling 225 may indicate that the common portion 210 of the messages 205 is mapped according to a non-interleaved operation (e.g., mapping the common portion 210 according to a non-interleaved mapping is fixed). In such cases, the network entity 105-a may transmit the control message 230-a indicating whether the private portion 215-a is mapped according to the interleaved operation or the non-interleaved operation. The network entity may perform the mapping of the common portion 210 and the private portions 215 according to techniques further described herein with reference to FIG. 5 and transmit the messages 205 to the UEs 115.

In such examples, if the UEs 115 indicate the capability to perform VRB-to-PRB interleaving with respect to the scheduled PRBs (e.g., rather than with respect to the entire physical bandwidth part of the UEs), the network entity may transmit control messages 230 that include a frequency domain resource allocation (FDRA) field (e.g., a field in a downlink control information (DCI) message indicating the scheduled RBs). The FDRA field in the control messages 230 may indicate the VRBs for the common portion 210 and the private portions 215, where the VRBs for the common portion 210 and the private portions 215 are the same. In such examples, the network entity 105-a may interleave the common portion 210 and the private portions 215 with respect to the frequency domain resource allocation (e.g., with respect to the PRBs). Additionally, or alternatively, the network entity 105-a may transmit control messages 230 that allocate resources for each UE 115 that span a same full downlink bandwidth part. In such examples, the network entity 105-a may map the common portion 210 and the private portions 215 to frequency resources that span the full downlink bandwidth part (e.g., full PRB allocation). The network entity may perform the mapping of the common portion 210 and the private portions 215 according to techniques further described herein with reference to FIG. 5 and transmit the messages 205 to the UEs 115.

FIG. 3 illustrates an example of a wireless communications system 300 that supports independent mapping of common and private transport blocks for rate splitting in accordance with one or more aspects of the present disclosure. The wireless communications system 300 may implement, or be implemented by, aspects of the wireless communications system 100, the wireless communications system 200, or both. For example, the wireless communications system 300 may include a network entity 105-b, a UE 115-c, and a UE 115-d, which may be examples of corresponding devices described herein with reference to FIGS. 1 and 2.

In the wireless communications system 300, the network entity 105-b may communicate one or more messages with the UE 115-c and the UE 115-d via one or more channels (e.g., broadcast channels or PDSCH). In some examples, the network entity 105-b may schedule a first message (e.g., W₁) for the UE 115-c and a second message (e.g., W2) for UE 115-d. In such examples, the network entity 105-b may use rate splitting operations 302 for transmission of the first message and the second message to achieve a relatively larger degree of freedom and capacity in the network (e.g., relative to systems that do not use rate splitting techniques). In such examples, the network entity 105-b may schedule the first message and the second message to be over overlapping resources (e.g., overlapping resource blocks and symbols).

In some examples of the rate splitting operations 302, the network entity 105-b may split the first message and the second message into a common portion 310 (e.g., part) and private portions 315, which may be examples of the common portion 210 and private portions 215 as described herein with reference to FIG. 2. That is, the network entity 105-a may split the first message into a common portion (e.g., W_{1,c}) and a private portion 315-a (e.g., W_{1,p}). Likewise, the network entity 105-b may split the second message into a common portion (e.g., W_{2,c}) and a private portion 315-b (e.g., W_{2,p}).

After splitting the first and second messages, the network entity 105-b may combine the common parts (e.g., W_{1,c} and W_{2,c}) to create the common portion 310 (e.g., W_{c}). For example, the common parts (e.g., W_{1,c} and W_{2,c}) may be concatenated together into the common portion 310 (e.g., W_{c}). The network entity 105-a may encode and modulate the common portion 310 into a common stream (e.g., X_{c}). In some examples, the network entity 105-b may encode and modulate the common stream over one or more physical layers in the channel (e.g., the encoding includes modulation and mapping to one or more layers). Further, the network entity 105-b may separately encode and modulate the private portions 315 (e.g., W_{1,p} and W_{2,p}) to respective private streams (e.g., X1 and X2) for the corresponding UEs 115.

The network entity 105-a may precode the common stream (e.g., X_{c}) using a precoder (e.g., P_{c}) and precode the private streams (e.g., X₁ and X₂) using respective precoders (e.g., P₁ and P₂). For example, the network entity 105-a may precode the private streams with the respective precoders based on one or more interference nulling techniques (e.g., based on knowledge of the channel at the network side) and interference cancellation performed at the UEs 115. That is, the network entity 105-b may choose the respective precoders (e.g., P₁ and P₂) such that the layers transmitted to the UE 115-c are not received by the UE 115-d, thereby enabling each UE 115 to receive the common portion 310 and respective private portions 315. Additionally, the network entity 105-b may rely on interference cancellation operations of the common stream at the UEs 115 to further decode the private streams. The network entity 105-b may map the precoded common stream and private streams to one or more transmission antennas and transmit the messages 305 to the UEs 115 (e.g., via one TRP or via multiple TRPs in coordinated multipoint scenarios).

For example, the network entity 105-a may precode the common stream (e.g., X_{c}) and the private streams (e.g., X₁ and X₂) using the respective precoders (e.g., P_{c}, P₁, and P₂) to create the messages 305 (e.g., X=P_{c}X_{c}+P₁X₁+P₂X₂), where the messages 305 include the common portion 310 (e.g., P_{c}X_{c}) and the private portions 315 (e.g., P₁X₁+P₂X₂). The messages 305 may be transmitted from the one or more antennas via the one or more channels to the UEs 115. In some cases, during the transmission of the messages 305, channel noise and interference may be distort the original signal (e.g., X=P_{c}X_{c}+P₁X₁+P₂X₂). In such cases, the signal (e.g., Y₁=H₁P_{c}X_{c}+H₁P₁X1+H₁P₂X₂+N₁) received by the UE 115-c may be different than the originally transmitted signal (e.g., X=P_{c}X_{c}+P₁X₁+P₂X₂). As such, the UEs 115 may perform channel estimation and decoding of the messages 305 using the decoding operations 312.

In some examples of the decoding operations 312, the UE 115-c may receive the message 305-a (e.g., Y₁=H₁P_{c}X_{c}+H₁P₁X₁+H₁P₂X₂+N₁) and perform channel estimations for the common stream (e.g., H₁P_{c}X_{c}) based on one or more DMRS ports in the received signal (e.g., message 305-a). Likewise, the UE 115-c may perform channel estimation for the private stream (e.g., H₁P₁X₁). The UE 115-c may first decode (e.g., perform demodulation and demapping in addition to decoding) the common stream (e.g., =H₁P_{c}X_{c}) to get the common portion 310 (e.g., W_{c}) and further identify the embedded common part (e.g., W_{1,c}) of the common portion 310 (e.g., W_{c}), which may contain data intended for the UE 115-c. Additionally, the UE 115-c may first decode the common stream for successive interference cancellation to further decode the private message.

For example, the UE 115-c may estimate the effective channel corresponding to the common stream (e.g., estimate H_{c}P_{c}), decode the common portion 310 (e.g., W_{c}), reconstruct (e.g., decode) the common stream (e.g., X_{c}), multiply by the estimated channel and subtract such estimation from the received signal (e.g., Y_{1,p}=Y₁−H₁P_{c}X_{c}=H₁P₁X₁+H₁P₂X₂+N₁). The UE 115-c may decode the private stream (e.g., X₁) to get the private portion 315-a (e.g., W_{1,p}) based on the decoded signal (e.g., Y_{1,p}) and the estimated channel (H₁P₁) of the private stream. Alternatively, the UE 115-c may use joint demodulation of the private stream and the common stream and subsequently decode the private portion 315-a and the common portion 310. As such, the UE 115-c may combine the private portion 315-a (e.g., W_{1,p}) and the common part (e.g., W_{1,c}) of the common portion 310 (e.g., W_{c}) to get the first message (e.g., W₁).

In some cases, however, the UE 115-c and the UE 115-d may have different physical bandwidth parts, such that the mapping from the allocated overlapping resources (e.g., VRB-to-PRB mapping) may differ between the UE 115-c and the UE 115-d. In such cases, the difference in resource mapping between the UE 115-c and the UE 115-d may prohibit both the UE 115-c and the UE 115-d from receiving the common portion 310 of the messages 305 via the same set of physical resources, thereby prohibiting the UEs 115 from decoding the private portions 315 of the messages 305.

Further, in some cases, the UE 115-c may support resource allocation according to a VRB-to-PRB interleaved mapping, while the UE 115-d may not support such resource allocation techniques. In such cases, both the common portion 310 and private portions 315 of the messages 305 may be mapped without interleaving (e.g., to accommodate the inability of the UE 115-d to support interleaved mapping), which may decrease a reliability of the message 305-a at the UE 115-c (e.g., as compared to cases where the common portion 310 and private portion 315-a of the message 305-a to the UE 115-c are interleaved, which improves a reliability of communications).

In some implementations of the wireless communications system 300, the network entity 105-b may independently map the common portion 310 and private portions 315 of the messages 305 to layers and resources. In some implementations, the network entity 105-b may map the common portion 310 via a non-interleaved operation, while mapping the private portions 315 via an interleaved operation. In such implementations, the network entity 105-b may interleave the allocated resources according to the allocated PRBs for each UE 115 (e.g., rather than across the entire bandwidth part of each UE 115), thereby reducing the likelihood of separate VRB-to-PRB mappings for the common portion 310 of the messages 305. Additionally, or alternatively, the network entity 105-b may allocate the same physical bandwidth part for the UE 115-c and the UE 115-d (e.g., an entire downlink bandwidth part), such that VRB-to-PRB mapping for the common portion 310 of the message 305-a and the message 305-b are the same across the entire bandwidth part.

FIG. 4 illustrates an example of a transmission diagram 400 that supports independent mapping of common and private transport blocks for rate splitting in accordance with one or more aspects of the present disclosure. The transmission diagram 400 may implement, or be implemented by, aspects of the wireless communications system 100, the wireless communications system 200, and the wireless communications system 300. For example, the transmission diagram 400 may be implemented by a network entity 105, a UE 115, or both as described herein with reference to FIGS. 1-3.

The transmission diagram 400 may include two examples of transmission chains 407 used for the transmission of a message 405 including a common portion 410 and a private portion 415. The transmission chain 407-a may be used by a network entity to transmit the rate-split message 405-a when the network entity maps the common portion 410-a and the private portion 415-a together. Additionally, the transmission chain 407-b may be used by a network entity to transmit the rate-split message 405-b when the network entity maps the common portion 410-b and the private portion 415-b independently.

For example, the network entity may use the transmission chain 407-a to transmit two separate transport blocks (e.g., TBs) (e.g., the common portion 410-a and the private portion 415-a of the message 405-a) a UE (e.g., via a PDSCH). In such examples, at 420-a, the network entity may encode and rate match the common portion 410-a (e.g., the first TB of the message 405-a) to generate a codeword (e.g., CW0). Likewise, at 420-b, the network entity may encode and rate match the private portion 415-a (e.g., the second TB of the message 405-a) to generate a second codeword (e.g., CW1). Further, at 425-a and 425-b, the network entity may scramble and modulate the first and second codewords to generate complex valued modulated symbols (e.g., complex CW0 and complex CW1).

At 430-a, the network entity may perform a single mapping operation on the common portion 410-a and the private portion 415-a to map the complex valued modulated symbols (e.g., CW0 and CW1) to transmission layers. For example, the network entity may combine (e.g., group together) one or more modulated symbols from the first and second complex codewords (e.g., combine symbols from CW0 and CW1) and map the combined symbols to one or more layers (e.g., v layers). The modulated symbol to layer mapping may be represented as a vector x(i). An example of the vector x(i) is shown below in Equation 1, where i corresponds to the modulated symbols in each layer, and M corresponds to the quantity of modulated symbols in each layer (e.g., a quantity of data resource elements).

$$x ( i ) = {[ {x}^{( 0 )} ( i ) … {x}^{( v - 1 )} ( i ) ]}^{T} , i = 0 , 1 , … , {M}_{Symbol}^{L a y e r} - 1 \qquad ( 1 )$$

At 435-a, the network entity may map each layer to an antenna port according to a one-to-one mapping. An example of a one-to-one mapping scheme is shown below in Equation 2, where antenna port y^{p(0)}(i) maps to layer x⁽⁰⁾(i).

$$[ \begin{matrix}{y}^{( {p}_{0} )} ( i ) \\ … \\ {y}^{( {p}_{v - 1} )} ( i )\end{matrix} ] = [ \begin{matrix}{x}^{( 0 )} ( i ) \\ … \\ {x}^{( v - 1 )} ( i )\end{matrix} ] \qquad ( 2 )$$

At 440-a, the network entity may map each antenna port to VRBs. At 445-a, the network entity may perform VRB-to-PRB mapping according to an interleaved or non-interleaved function and transmit the message 405-a, including the common portion 410-a and the private portion 415-a, to another wireless device (e.g., a UE).

In the example of the transmission chain 407-a, mapping the modulated symbols to the layers for the common portion 410-a and the private portion 415-a (e.g., CW0 and CW1) may set (e.g., fix or decide) which modulated symbols of the first and second codewords are mapped to same resources across the different layers. As such, it may not be possible to do separate VRB-to-PRB mapping (e.g., due to mapping CW0 and CW1 together over the same resources). Thus, in the example of the transmission chain 407-a, the network entity may map the private portion 415-a (e.g., which may correspond to CW1) and the common portion 410-a (e.g., which may correspond to CW0) to the same resources and may use the same VRB-to-PRB mapping, thereby eliminating the ability for the network entity to map the private portion 415-a and the common portion 410-a independently.

In some implementations of the present disclosure, the network entity may use the transmission chain 407-b to independently map the common portion 410-b of a message 405-b and a private portion 415-b of the message 405-b while using rate splitting. For example, the network entity may transmit the common portion 410-b (e.g., CW0) and the private portion 415-b (e.g., CW1) in a channel (e.g., PDSCH or broadcast channel), where the modulated symbols of the common portion 410-b and the private portion 415-b may be separately mapped to layers, separately mapped to resources (e.g., mapping to VRBs and VRB-to-PRB mapping), and mapped to antenna ports for the channel. As such, during rate splitting, the network entity may be able to perform an interleaved VRB-to-PRB operation for the private portion 415-b and a non-interleaved VRB-to-PRB mapping for the common portion 410-b.

For example, at 420-c and 420-d, the network entity may encode and rate match the common portion 410-b and the private portion 415-b to generate a common codeword (e.g., CW0, common stream) and a private codeword (e.g., CW1, private stream), respectively. At 425-c and 425-d, the network entity may scramble and modulate the common codeword and the private codeword to generate complex modulated symbols for the common portion 410-b and the private portion 415-b, respectively.

At 430-b, the network entity may independently map the complex modulated symbols for the common portion 410-b (e.g., the CW0) to layers (e.g., v1 layers). An example of the modulated symbol to layer mapping at 430-b may be represented as a vector x_{c-CW}(i), which is defined below in Equation 3. where i represents each symbol of a layer. In Equation 3, i may correspond to a symbol of a layer.

$${x}_{c - CW} ( i ) = {[ {x}_{c - c W}^{( 0 )} ( i ) … {x}_{c - c W}^{( {v}_{1} - 1 )} ( i ) ]}^{T} \qquad ( 3 )$$

Likewise, at 430-c, the network entity may map the complex modulated symbols for the private codeword to layers (e.g., v2 layers) independently of the mapping performed at 430-b, such that the combination of layers mapped for the common codeword and the private codeword span the available layers (e.g., v1+v2=v). The modulated symbol to layer mapping may be represented as a vector x_{p-CW}(i). An example definition of the vector x_{p-CW}(i) is illustrated below in Equation 4, where i may represent each symbol of a layer.

$${x}_{p - C W} ( i ) = {[ {x}_{p - c W}^{( 0 )} ( i ) … {x}_{p - c W}^{( {v}_{2} - 1 )} ( i ) ]}^{T} \qquad ( 4 )$$

At 440-b, the network entity may independently map the modulated symbols and mapped layers of the common portion 410-b (e.g., CW0) to VRBs. Likewise, at 440-c, the network entity may independently map (e.g., independently of the mapping at 440-b) the modulated symbols and mapped layers of the private portion 415-b (e.g., CW1) to VRBs. The network entity may map the modulated symbols of the common portion 410-b to the same VRBs (or different VRBs) as those of the private portions 415.

At 445-b, the network entity may map the VRBs of the common portion 410-b to PRBs according to a non-interleaved operation or an interleaved operation. Likewise, at 445-c, the network entity may independently map the VRBs of the private portion 415-b to PRBs according to the non-interleaved operation or the interleaved operation. As a result, the network entity may determine to map the modulated symbols of the private portion 415-b and the common portion 410-b to the same (or different) resources after separately and independently mapping to such symbols to the VRBs. At 435-b and after mapping the common portion 410-b and the private portion 41-b to the PRBs, the network entity may map the modulated symbols of the common portion 410-b and the private portion 415-b to different antenna ports of the channel.

By performing an independent mapping of the common portion 410-b and the private portion 415-b of the message 405-b to layers, VRBs, and VRB-to-PRBs, the network entity may have the flexibility to determine the mapping operations according to the capabilities of one or more UEs 115 for rate splitting. For example, if a first UE 115 and a second UE 115 have different allocated bandwidth part sizes or if the first UE 115 supports interleaving operations and the second UE 115 does not, the network entity may perform a non-interleaved VRB-to-PRB operation (at 445-b) for the common portion 410-b, such that the PRBs for the common portion 410-b are the same across the first UE and the second UE. In such examples, the network entity may perform an interleaved operation for the private portion 415-b, thereby improving communications between the first UE 115 and the network entity by using the benefits of an interleaved VRB-to-PRB operation. Additionally, or alternatively, the network entity may perform the resource mapping (e.g., VRB mapping and VRB-to-PRB mapping) in one step (e.g., combine steps 440 and 445) with or without the VRB-to-PRB interleaving operation (e.g., with frequency interleaving for resource mapping of the private portion 415-b and without frequency interleaving for resource mapping of the common portion 410-b).

FIG. 5 illustrates an example of a resource mapping diagram 500 that supports independent mapping of common and private transport blocks for rate splitting in accordance with one or more aspects of the present disclosure. The resource mapping diagram 500 may implement, or be implemented by, the wireless communications system 100, the wireless communications system 200, the wireless communications system 300, and the transmission diagram 400 as described herein with reference to FIGS. 1-4. For example, the resource mapping diagram 500 may be implemented by a network entity 105, one or more UEs 115, or both as described herein.

The resource mapping diagram 500 may include a mapping scheme 505, a mapping scheme 510, and a mapping scheme 515, which may be based on resource allocations for use in rate splitting. For example, the network entity may communicate with one or more UEs using rate splitting techniques as described herein with reference to FIGS. 2 and 3. In such examples, the network entity may allocate resources for transmission of a common portion (to be sent to both UEs) and resources for a private portion (to be sent and decoded by each UE respectively) according to a first type of resource allocation (e.g., resource allocation type 0) or a second type of resource allocation (e.g., resource allocation type 1).

In the first type of resource allocation, the network entity may allocate a group of resource blocks (e.g., resource block group (RBG)) that span a physical bandwidth part. The network entity may indicate the total quantity of allocated resource blocks (e.g., N_RBG) in a bandwidth part via control messaging (e.g., DCI), where the field within the control messaging for the quantity of resource blocks acts as a bitmap indicating the scheduled RBGs out of the total quantity of allocated resource blocks (e.g., out of all N_RBG RBGs). Additionally, the control message may indicate the RBG size (e.g., a P parameter), where the RBG size (e.g., 2, 4, 8, or 16 RBGs) may depend on the bandwidth part size and higher layer signaling (e.g., RRC messaging).

In the second type of resource allocation, the network entity may allocate a set of VRB bundles to be used in mapping to one or more PRBs. For example, the network entity may indicate, via a field (e.g., FDRA field) in the control messaging, the start of the allocated VRBs, in addition to, a quantity of VRBs. Further, the network entity may indicate, via a separate field in the control messaging, a VRB-to-PRB mapping, which if set to a 1, may indicate that the network entity may perform a VRB-to-PRB mapping according to an interleaved operation (e.g., the PRBs mapped to the VRBs are not contiguous and may be interleaved according to an interleaving function). For example, if the VRB-to-PRB mapping field is set to 0, the network entity may map the VRBs to PRBs according to a non-interleaved operation, where VRB N is mapped to PRB N (e.g., due to the PRBs being contiguous in the PRB domain.

Alternatively, if the VRB-to-PRB mapping field is set to 1, the network entity may map the VRBs to PRBs according to an interleaved operation, where the resource block bundles are formed in both the VRB domain and the PRB domain within a given bandwidth part. In such cases, the network entity may indicate the resource block bundle size (e.g., L) via higher layer parameters (e.g., via a vrb-toPRB-Interleaver parameter), where the bundle size can be two or four resource blocks. In such cases, a first VRB bundle (e.g., VRB bundle j) may be mapped to a first PRB bundle according to an interleaving function (e.g., VRB bundle j maps to PRB bundle f (j)). In such cases, the network entity may perform the VRB-to-PRB interleaving operation with respect to the bandwidth part size instead of the frequency domain resource allocation.

Interleaved VRB-to-PRB mapping may be beneficial for use in rate splitting due to a larger quantity of layers, and larger (e.g., or more complex) modulation and coding schemes, used for the private portion compared to the common portion. That is, the private portion may have multiple code blocks in a single OFDM symbol, where without VRB-to-PRB interleaving operations, the frequency diversity may not be realized for a given code block. In contrast, the common portion may not have multiple code blocks per OFDM symbol due to a smaller TB size (e.g., due to a smaller quantity of layers and smaller MCS).

In cases of rate splitting, however, if a first UE and a second UE have different bandwidth part sizes, the network entity may not map the common portion of the messages to the same PRBs due to different interleaving functions associated with each UE. For example, in the mapping scheme 505), a first UE may be allocated a bandwidth part size that spans eight (e.g., 0-7) resource blocks (e.g., eight VRBs and PRBs). Alternatively, in the mapping scheme 515, the second UE may be allocated a bandwidth part size that spans ten (e.g., 0-9) resource blocks. Using rate splitting techniques, the network entity may allocate, in the VRB domain (e.g., FDRA domain), the same VRB bundle locations (e.g., same frequency locations) for transmission of the common portion. That is, the network entity may allocate for the first UE, VRB bundles 1, 2, 3, and 4, while allocating for the second UE the VRB bundles 2, 3, 4, and 5. In such examples, the frequency locations of the VRB bundles in the mapping scheme 505 and the frequency locations of the VRB bundles in the mapping scheme 510 may be in the same frequency location, but indexed differently due to different bandwidth part allocations between the two UEs. Due to VRB-to-PRB interleaving options being with respect to the total bandwidth part (e.g., resources 0-7 in mapping scheme 505 and resources 0-9 in mapping scheme 510), the network entity may map the VRBs for the common portion (e.g., which span the same frequency locations in the VRB domain) to different PRB locations. For example, the mapped PRBs in mapping scheme 505 may have different frequency locations than the PRBs in mapping scheme 510, thereby reducing the reliability of the common portion.

Further, in some cases of rate splitting, the first UE may support VRB-to-PRB interleaving, while the second UE may not support such techniques. Thus, the common codeword and private codeword for each UE may not be interleaved, thereby degrading the communication of the common portion and private portions (e.g., due to the second UE not support interleaving).

In some implementations of the present disclosure, the network entity may perform an interleaved VRB-to-PRB mapping for the private portion of the message and a non-interleaved VRB-to-PRB mapping for the common portion of the message, while the allocated VRBs and occupied PRBs are the same across the common and private portion. For example, the network entity may allocate the same VRBs for both the common portion and private portion for the first UE via a control message (e.g., DCI) that schedules the common portion (e.g., common codeword) and the private portion (e.g., private codeword) of the PDSCH. In such examples, the control message may include an FDRA field indicating VRBs for both the common and private portion.

In some examples, in order to perform VRB-to-PRB interleaving for the private portion and non-interleaving for VRB-to-PRB mapping for the common codeword, the network entity may perform interleaving on the allocated VRBs with respect to the scheduled PRBs (e.g., and not with respect to the bandwidth part). In such examples, the FDRA in the control message may indicate the scheduled PRBs, where the scheduled PRBs are re-indexed from zero to the allocated size of the PRBs (e.g., 0, 1, . . . , n_PRB). The network entity may change the order of mapping the modulated symbols to the allocated PRBs, but may not change the allocated PRBs. Such interleaving may be done according to the first resource allocation type (e.g., type 0 resource allocation) or the second resource allocation type (e.g., type 1 resource allocation). For example, in the mapping scheme 515, the network entity may indicate, via the FDRA in the control message, that PRB bundles 1, 2, 3, and 4 are allocated for both the common portion and private portion. As such, the network entity may perform VRB-to-PRB according to interleaving the VRB-to-PRB within the allocated FDRA, instead of the total bandwidth part.

In some examples, in order to perform VRB-to-PRB interleaving for the private portion and non-interleaving for VRB-to-PRB mapping for the common portion, the network entity may allocate full resource allocation to the UEs. For example, the network entity may indicate the whole downlink bandwidth part for transmission of the common portion and private portions to each UE. In such examples, the network may configure the same bandwidth part size across each UE, such that the VRB-to-PRB mapping for the common portion may be the same between each UE.

In such examples of VRB-to-PRB interleaving for the private portion and non-interleaving for VRB-to-PRB mapping for the common portion, the network entity may transmit control messaging (e.g., scheduling DCI) that indicates whether the VRBs of the common portion (e.g., common code word CW0) and the private portion (e.g., private code word CW1) are mapped to the PRBs according to an interleaved or non-interleaved operation. For example, two bits may be indicated in the control message, where a first bit indicates whether the VRB-to-PRB mapping for the common portion is mapped according to the interleaved or non-interleaved operation. Likewise, the second bit may be used to indicate whether the VRB-to-PRB mapping for the private portion is mapped according to the interleaved or non-interleaved operation. Alternatively, an additional VRB-to-PRB mapping field with a single bit may be added to the existing control message to indicate such functionality.

To inform the UEs that the control message may include such indications (e.g., the VRB-to-PRB mapping field or additional two bits), the network entity may transmit higher layer signaling (e.g., RRC messages) that enables the addition of the indications in the control messaging. Such higher layer signaling may be configured for different control messages (e.g., different DCI formats such as format 1_1 versus format 1_2). Further, in some examples, the UEs may operate under a fixed assumption that the VRB-to-PRB mapping for the common portion of a message in rate splitting is according to a non-interleaved operation. In these examples, the UEs may receive the control message indicating scheduling for the common portion and private portion and determine that rate splitting techniques may be used for transmission of a message. In such examples, the UEs may operate under the fixed assumption that the common portion may be mapped according to a non-interleaved operation. Additionally, or alternatively, the network entity may transmit higher layer signaling (e.g., such as RRC messaging) that enables the fixed assumption, otherwise the UEs may determine that the common and private portions may have the same VRB-to-PRB mapping as indicated via the control messaging (e.g., existing DCI field).

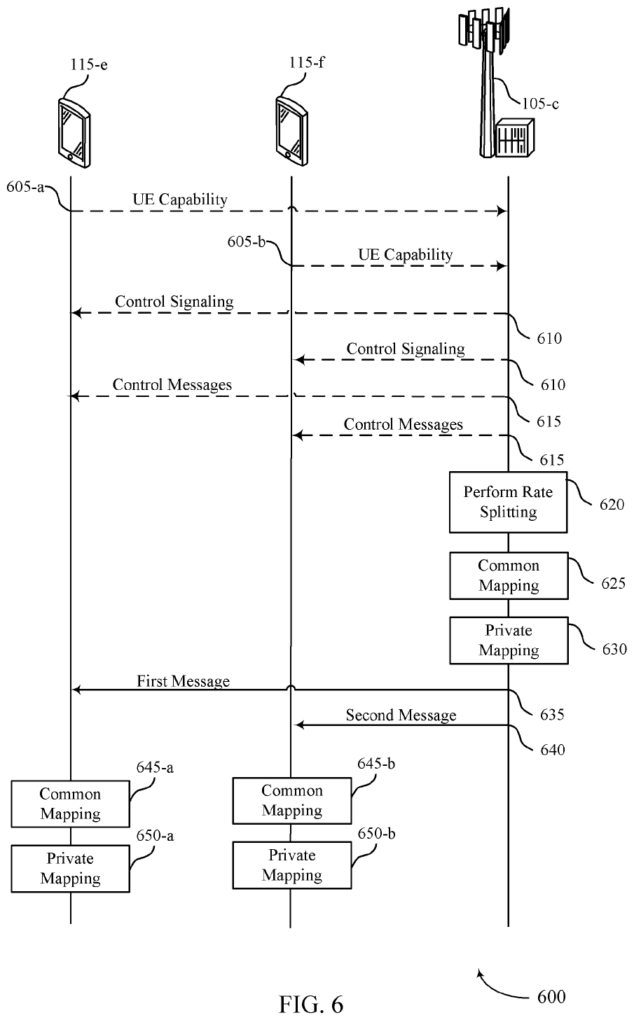

FIG. 6 illustrates an example of a process flow 600 that supports independent mapping of common and private transport blocks for rate splitting in accordance with one or more aspects of the present disclosure. The process flow 600 may implement, or be implemented by, aspects of the wireless communications system 100, the wireless communications system 200, the wireless communications system 300, the transmission diagram 400, and the resource mapping diagram 500 as described herein with reference to FIGS. 1-5. The process flow 600 may include a network entity 105-c, a UE 115-e, and a UE 115-f, which may be examples of corresponding devices described herein. In the following description of the process flow 600, the operations may be performed in a different order than the order shown. Specific operations also may be left out of the process flow 600, or other operations may be added to the process flow 600. Further, although some operations or signaling may be shown to occur at different times for discussion purposes, these operations may actually occur at the same time.

At 605-a and 605-b, the UEs 115 may optionally transmit UE capability messages to the network entity 105-c. For example, the UEs 115 may indicate a capability to perform rate splitting in communications with the network entity 105-c. In some examples, the UEs 115 may indicate a capability to decode a message that includes a first portion that is mapped independently of a second portion (e.g., the common portion and private portion of a message are mapped independently). In some examples, the UEs 115 may indicate a capability to decode a message that includes a first portion mapped according to an interleaved mapping (e.g., VRB-to-PRB mapping of the private portion of a message according to an interleaved operation) and a second portion mapped according to a non-interleaved mapping (e.g., VRB-to-PRB mapping of common portion of a message according to a non-interleaved operation). In some examples, the UEs 115 may indicate a capability to decode a message that is mapped to a set of frequency resources (e.g., bandwidth part) according to an interleaving mapping operation within PRBs that span the set of frequency resources. That is, the UEs 115 may indicate a capability to decode a message that has been interleaved with respect to the FDRA (e.g., instead of the total allocated bandwidth part).

At 610, the network entity 105-c may optionally transmit to the UEs 115, control signaling (e.g., higher layer signaling) that indicates a configuration for one or more control messages, where the configuration of the one or more control messages includes whether a first portion (e.g., common portion) and a second portion (e.g., private portion) of a first message are mapped according to an interleaved mapping or a non-interleaved mapping.

At 615, the network entity 105-c may optionally transmit one or more control messages to the UEs 115. The one or more control messages may include an indication that one or more VRBs and PRBs that span a set of frequency resources are the same for transmitting the first portion and the second portion of the first message. In some examples, the one or more control messages may include a second indication that the set of frequency resources for transmission of the first message and a second message span a downlink bandwidth part size (e.g., the UEs 115 are configured with the same bandwidth part size), where a first mapping operation and a second mapping operation are for the total downlink bandwidth part (e.g., the common and private portion mapping is done with respect to the total allocated bandwidth part). In some examples, the one or more control messages may include a first indication of whether the first mapping operation includes interleaving and a second indication of whether the second mapping operation includes interleaving. In such examples, the one or more control messages may be based on the indications included in the control signaling at 615.

At 620, the network entity 105-c may perform rate splitting on the first message for the UE 115-e and the second message for the UE 115-f, where the first message includes a first common portion and a first private portion, and the second message includes a second common portion and a second private portion. The rate splitting may include combining the first common portion and first private portion into a third common portion according to techniques described herein with reference to FIGS. 2 and 3.

At 625, the network entity 105-c may perform a first mapping operation to map the third common portion to one or more first PRBs. In some examples, the first mapping operation may be based on the indications received in the control signaling and control messages. The network entity 105-c may map the third common portion to the one or more first PRBs according to techniques described herein with reference to FIGS. 4 and 5.

At 630. the network entity 105-c may perform a second mapping operation to map the first private portion to one or more second PRBs. Additionally, the network entity 105-c may perform a third mapping operation to map the second private portion to one or more third PRBs. In some examples, the second and third mapping operations may be based on the indications received in the control signaling and control messages. In accordance with the techniques described herein, the second mapping operation and the third mapping operation may be done independently of the first mapping operation. For example, the network entity 105-c may map first and second private portions to the one or more second PRBs and the one or more third PRBs according to techniques described herein with reference to FIGS. 4 and 5.

At 635, the network entity 105-c may transmit the first message to the UE 115-e, where the first message includes the third common portion and the first private portion. At 640, the network entity 105-c may transmit the second message to the UE 115-f, where the second message includes the third common portion and the second private portion.

At 645-a, the UE 115-e may receive the first message and perform a first mapping operation to obtain the first common portion based on the first mapping between the third common portion and the PRBs. Likewise, at 645-b, the UE 115-f may receive the second message and perform the first mapping operation to obtain the second common portion based on the first mapping between the third common portion and the PRBs. The UEs 115 may perform the first mapping operation (e.g., decode the common portion) in accordance with techniques described herein with reference to FIG. 3.

At 650-a, the UE 115-e may perform a second mapping operation, independent of the first mapping operation, to obtain the first private portion of the first message based on the second mapping between the PRBs and the first private portion. Likewise, at 650-b, the UE 115-f may perform a third mapping operation, independent of the first and second mapping operations, to obtain the second private portion. The UEs 115 may perform the second and third mapping operations (e.g., decode the private portions of the respective messages) in accordance with techniques described herein with reference to FIG. 3.

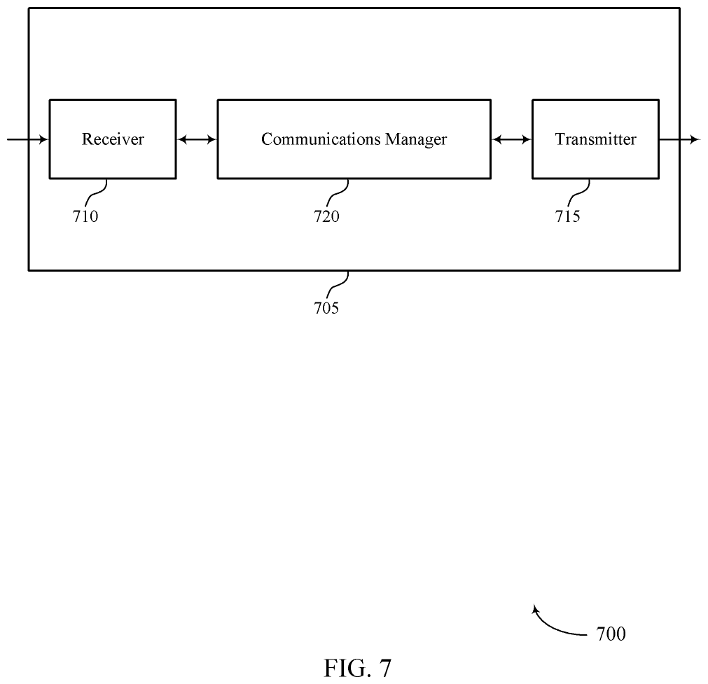

FIG. 7 illustrates a block diagram 700 of a device 705 that supports independent mapping of common and private transport blocks for rate splitting in accordance with one or more aspects of the present disclosure. The device 705 may be an example of aspects of a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The communications manager 720, the receiver 710, the transmitter 715, or various combinations thereof or various components thereof may be examples of means for performing various aspects of independent mapping of common and private transport blocks for rate splitting as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a network entity in accordance with examples as disclosed herein. For example, the communications manager 720 may be configured as or otherwise support a means for performing rate splitting on a first message for a first UE and a second message for a second UE, the first message including a first common portion and a first private portion, and the second message including a second common portion and a second private portion, the rate splitting including combining the first common portion and the second common portion into a third common portion. The communications manager 720 may be configured as or otherwise support a means for performing a first mapping operation to map the third common portion to one or more first PRBs for transmission. The communications manager 720 may be configured as or otherwise support a means for performing a second mapping operation that is independent of the first mapping operation, the second mapping operation to map the first private portion to one or more second PRBs for transmission. The communications manager 720 may be configured as or otherwise support a means for transmitting, based on performing the first mapping operation and the second mapping operation and using the one or more first PRBs and the one or more second PRBs, the third common portion and the first private portion to the first UE via the first message.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for efficient utilization of resources for rate splitting, which may reduce processing, reduce power consumption, and improve efficient utilization of communication resources.

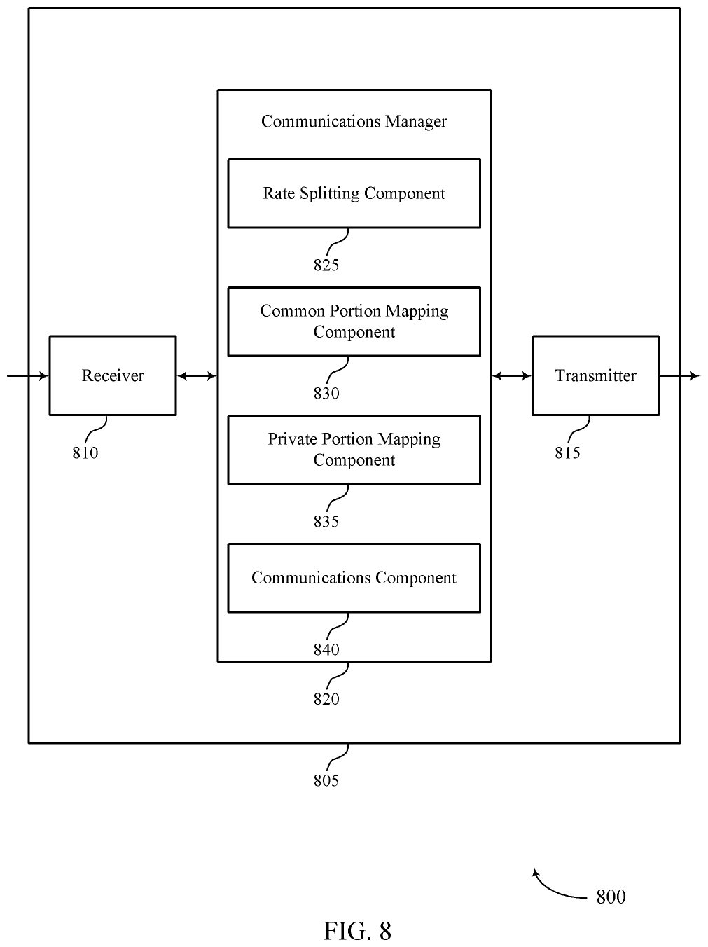

FIG. 8 illustrates a block diagram 800 of a device 805 that supports independent mapping of common and private transport blocks for rate splitting in accordance with one or more aspects of the present disclosure. The device 805 may be an example of aspects of a device 705 or a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The device 805, or various components thereof, may be an example of means for performing various aspects of independent mapping of common and private transport blocks for rate splitting as described herein. For example, the communications manager 820 may include a rate splitting component 825, a common portion mapping component 830, a private portion mapping component 835, a communications component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a network entity in accordance with examples as disclosed herein. The rate splitting component 825 may be configured as or otherwise support a means for performing rate splitting on a first message for a first UE and a second message for a second UE, the first message including a first common portion and a first private portion, and the second message including a second common portion and a second private portion, the rate splitting including combining the first common portion and the second common portion into a third common portion. The common portion mapping component 830 may be configured as or otherwise support a means for performing a first mapping operation to map the third common portion to one or more first PRBs for transmission. The private portion mapping component 835 may be configured as or otherwise support a means for performing a second mapping operation that is independent of the first mapping operation, the second mapping operation to map the first private portion to one or more second PRBs for transmission. The communications component 840 may be configured as or otherwise support a means for transmitting, based on performing the first mapping operation and the second mapping operation and using the one or more first PRBs and the one or more second PRBs, the third common portion and the first private portion to the first UE via the first message.

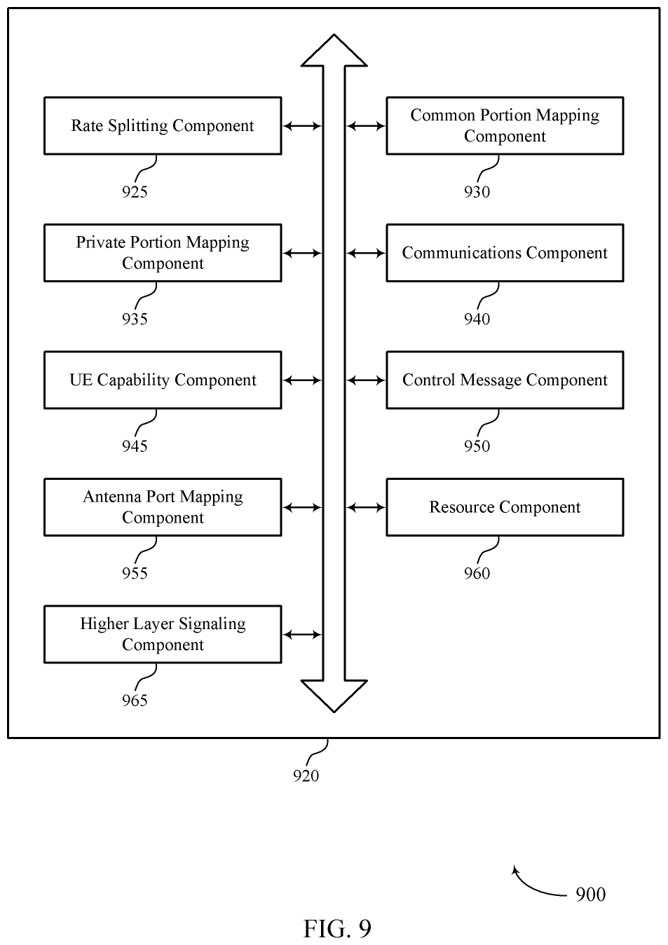

FIG. 9 illustrates a block diagram 900 of a communications manager 920 that supports independent mapping of common and private transport blocks for rate splitting in accordance with one or more aspects of the present disclosure. The communications manager 920 may be an example of aspects of a communications manager 720, a communications manager 820, or both, as described herein. The communications manager 920, or various components thereof, may be an example of means for performing various aspects of independent mapping of common and private transport blocks for rate splitting as described herein. For example, the communications manager 920 may include a rate splitting component 925, a common portion mapping component 930, a private portion mapping component 935, a communications component 940, a UE capability component 945, a control message component 950, an antenna port mapping component 955, a resource component 960, a higher layer signaling component 965, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 920 may support wireless communication at a network entity in accordance with examples as disclosed herein. The rate splitting component 925 may be configured as or otherwise support a means for performing rate splitting on a first message for a first UE and a second message for a second UE, the first message including a first common portion and a first private portion, and the second message including a second common portion and a second private portion, the rate splitting including combining the first common portion and the second common portion into a third common portion. The common portion mapping component 930 may be configured as or otherwise support a means for performing a first mapping operation to map the third common portion to one or more first PRBs for transmission. The private portion mapping component 935 may be configured as or otherwise support a means for performing a second mapping operation that is independent of the first mapping operation, the second mapping operation to map the first private portion to one or more second PRBs for transmission. The communications component 940 may be configured as or otherwise support a means for transmitting, based on performing the first mapping operation and the second mapping operation and using the one or more first PRBs and the one or more second PRBs, the third common portion and the first private portion to the first UE via the first message.

In some examples, the UE capability component 945 may be configured as or otherwise support a means for receiving, from the first UE, signaling indicating that the first UE is capable of decoding a message including a first portion that is mapped independently of a second portion, where performing the rate splitting on the first message and the second message is based on receiving the signaling.

In some examples, the UE capability component 945 may be configured as or otherwise support a means for receiving, from the first UE, signaling indicating whether the first UE is capable of decoding a message including a first portion that is mapped according to an interleaved mapping operation and a second portion that is mapped according to a non-interleaved mapping operation, where performing the first mapping operation and the second mapping operation is based on receiving the signaling from the UE.

In some examples, the UE capability component 945 may be configured as or otherwise support a means for receiving, from the first UE, signaling indicating whether the first UE is capable of decoding a message that is mapped to a set of frequency resources by interleaving the message within PRBs that span the set of frequency resources, where the set of frequency resources are allocated for the message and span a portion of a downlink bandwidth part, and where performing the first mapping operation and the second mapping operation is based on receiving the signaling from the UE.

In some examples, the common portion mapping component 930 may be configured as or otherwise support a means for performing the first mapping operation includes mapping the third common portion to the one or more first PRBs according to a non-interleaved mapping. In some examples, the private portion mapping component 935 may be configured as or otherwise support a means for performing the second mapping operation includes mapping the first private portion to the one or more second PRBs according to an interleaved mapping.

In some examples, the control message component 950 may be configured as or otherwise support a means for transmitting, to the first UE, a control message including an indicator of a set of frequency resources for a transmission of the first message, where the one or more first PRBs and the one or more second PRBs each span the set of frequency resources, and where performing the first mapping operation and the second mapping operation is based on transmitting the control message.

In some examples, the set of frequency resources span a portion of frequency resources within a downlink bandwidth part. In some examples, performing the second mapping operation includes interleaving the first private portion within the set of frequency resources to map the first private portion to the one or more second PRBs.

In some examples, the control message component 950 may be configured as or otherwise support a means for transmitting, to the second UE, a second control message including a second indicator of the set of frequency resources for a transmission of the second message, where the set of frequency resources span a downlink bandwidth part, and where performing the first mapping operation and the second mapping operation is based on transmitting the second control message.

In some examples, the control message component 950 may be configured as or otherwise support a means for transmitting, to the first UE, a control message including a first indication of whether the first mapping operation includes interleaving and a second indication of whether the second mapping operation includes interleaving, where performing the first mapping operation and the second mapping operation is based on transmitting the control message.

In some examples, the higher layer signaling component 965 may be configured as or otherwise support a means for transmitting, to the first UE, signaling indicating that the control message includes the first indication and the second indication, where transmitting the control message is based on transmitting the signaling.

In some examples, the communications component 940 may be configured as or otherwise support a means for transmitting, to the first UE, signaling indicating that mapping operations performed on common portions of messages include non-interleaved mapping. In some examples, the control message component 950 may be configured as or otherwise support a means for transmitting, to the first UE and based on transmitting the signaling, a control message including an indication of whether the second mapping operation includes interleaving. In some examples, the common portion mapping component 930 may be configured as or otherwise support a means for performing the first mapping operation includes mapping the third common portion to the one or more first PRBs according to a non-interleaved mapping. In some examples, the private portion mapping component 935 may be configured as or otherwise support a means for performing the second mapping operation includes mapping the first private portion according to a non-interleaved mapping or an interleaved mapping in accordance with the indication of whether the second mapping operation includes interleaving.

In some examples, performing the first mapping operation further includes mapping the third common portion to one or more first layers for transmission. In some examples, performing the second mapping operation further includes mapping the first private portion to one or more second layers for transmission independently of mapping the third common portion to the one or more first layers for transmission.

In some examples, the antenna port mapping component 955 may be configured as or otherwise support a means for mapping, based on performing the first mapping operation and the second mapping operation, the third common portion and the first private portion of the first message to one or more antenna ports at the network entity, where transmitting the third common portion and the first private portion is based on mapping the third common portion and the first private portion to the one or more antenna ports.

In some examples, the private portion mapping component 935 may be configured as or otherwise support a means for performing a third mapping operation that is independent of the first mapping operation and the second mapping operation, the third mapping operation to map the second private portion to one or more third PRBs for transmission. In some examples, the communications component 940 may be configured as or otherwise support a means for transmitting, based on performing the first mapping operation and the third mapping operation and using the one or more first PRBs and the one or more third PRBs, the third common portion and the second private portion to the second UE via the second message.

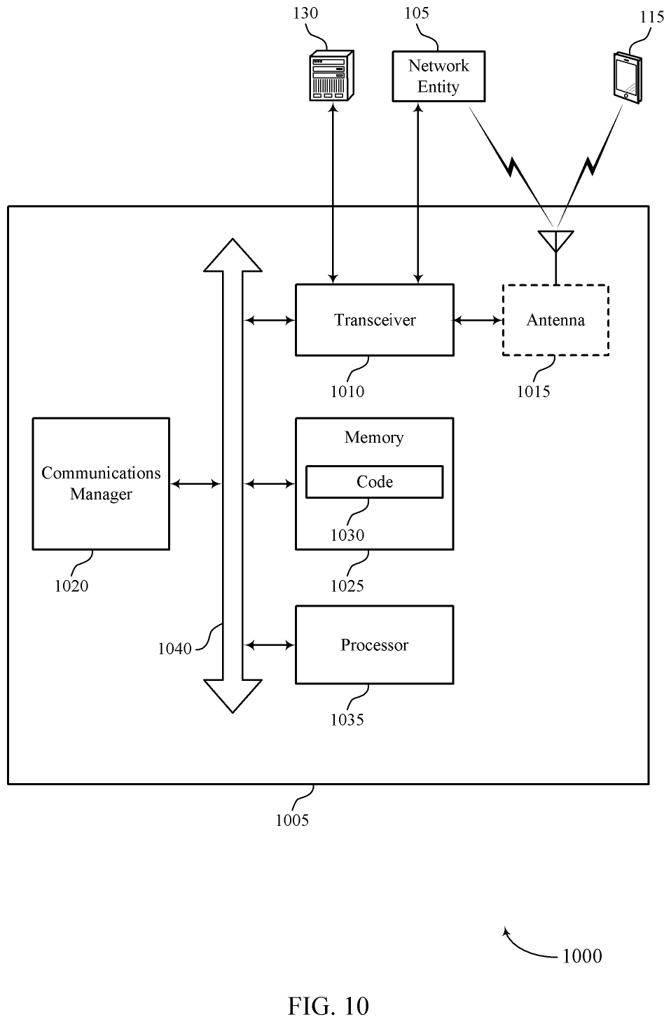

FIG. 10 illustrates a diagram of a system 1000 including a device 1005 that supports independent mapping of common and private transport blocks for rate splitting in accordance with one or more aspects of the present disclosure. The device 1005 may be an example of or include the components of a device 705, a device 805, or a network entity 105 as described herein. The device 1005 may communicate with one or more network entities 105, one or more UEs 115, or any combination thereof, which may include communications over one or more wired interfaces, over one or more wireless interfaces, or any combination thereof. The device 1005 may include components that support outputting and obtaining communications, such as a communications manager 1020, a transceiver 1010, an antenna 1015, a memory 1025, code 1030, and a processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or memory components (for example, the processor 1035, or the memory 1025, or both), may be included in a chip or chip assembly that is installed in the device 1005. In some examples, the transceiver may be operable to support communications via one or more communications links (e.g., a communication link 125, a backhaul communication link 120, a midhaul communication link 162, a fronthaul communication link 168).

The memory 1025 may include RAM and ROM. The memory 1025 may store computer-readable, computer-executable code 1030 including instructions that, when executed by the processor 1035, cause the device 1005 to perform various functions described herein. The code 1030 may be stored in a non-transitory computer-readable medium such as system memory or another type of memory. In some cases, the code 1030 may not be directly executable by the processor 1035 but may cause a computer (e.g., when compiled and executed) to perform functions described herein. In some cases, the memory 1025 may contain, among other things, a BIOS which may control basic hardware or software operation such as the interaction with peripheral components or devices.

The processor 1035 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1035 may be configured to operate a memory array using a memory controller. In some other cases, a memory controller may be integrated into the processor 1035. The processor 1035 may be configured to execute computer-readable instructions stored in a memory (e.g., the memory 1025) to cause the device 1005 to perform various functions (e.g., functions or tasks supporting independent mapping of common and private transport blocks for rate splitting). For example, the device 1005 or a component of the device 1005 may include a processor 1035 and memory 1025 coupled with the processor 1035, the processor 1035 and memory 1025 configured to perform various functions described herein. The processor 1035 may be an example of a cloud-computing platform (e.g., one or more physical nodes and supporting software such as operating systems, virtual machines, or container instances) that may host the functions (e.g., by executing code 1030) to perform the functions of the device 1005. The processor 1035 may be any one or more suitable processors capable of executing scripts or instructions of one or more software programs stored in the device 1005 (such as within the memory 1025). In some implementations, the processor 1035 may be a component of a processing system. A processing system may generally refer to a system or series of machines or components that receives inputs and processes the inputs to produce a set of outputs (which may be passed to other systems or components of, for example, the device 1005). For example, a processing system of the device 1005 may refer to a system including the various other components or subcomponents of the device 1005, such as the processor 1035, or the transceiver 1010, or the communications manager 1020, or other components or combinations of components of the device 1005. The processing system of the device 1005 may interface with other components of the device 1005, and may process information received from other components (such as inputs or signals) or output information to other components. For example, a chip or modem of the device 1005 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1005 may transmit information output from the chip or modem. Additionally, or alternatively, in some implementations, the one or more interfaces may refer to an interface between the processing system of the chip or modem and a receiver, such that the device 1005 may obtain information or signal inputs, and the information may be passed to the processing system. A person having ordinary skill in the art will readily recognize that a first interface also may obtain information or signal inputs, and a second interface also may output information or signal outputs.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the memory 1025, the code 1030, and the processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with other network entities 105, and may include a controller or scheduler for controlling communications with UEs 115 in cooperation with other network entities 105. In some examples, the communications manager 1020 may support an X₂ interface within an LTE/LTE-A wireless communications network technology to provide communication between network entities 105.

The communications manager 1020 may support wireless communication at a network entity in accordance with examples as disclosed herein. For example, the communications manager 1020 may be configured as or otherwise support a means for performing rate splitting on a first message for a first UE and a second message for a second UE, the first message including a first common portion and a first private portion, and the second message including a second common portion and a second private portion, the rate splitting including combining the first common portion and the second common portion into a third common portion. The communications manager 1020 may be configured as or otherwise support a means for performing a first mapping operation to map the third common portion to one or more first PRBs for transmission. The communications manager 1020 may be configured as or otherwise support a means for performing a second mapping operation that is independent of the first mapping operation, the second mapping operation to map the first private portion to one or more second PRBs for transmission. The communications manager 1020 may be configured as or otherwise support a means for transmitting, based on performing the first mapping operation and the second mapping operation and using the one or more first PRBs and the one or more second PRBs, the third common portion and the first private portion to the first UE via the first message.

By including or configuring the communications manager 1020 in accordance with examples as described herein, the device 1005 may support techniques for efficient utilization of resources for rate splitting, which may improve communication reliability, reduce power consumption, and increase efficient utilization of communication resources.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, the processor 1035, the memory 1025, the code 1030, or any combination thereof. For example, the code 1030 may include instructions executable by the processor 1035 to cause the device 1005 to perform various aspects of independent mapping of common and private transport blocks for rate splitting as described herein, or the processor 1035 and the memory 1025 may be otherwise configured to perform or support such operations.

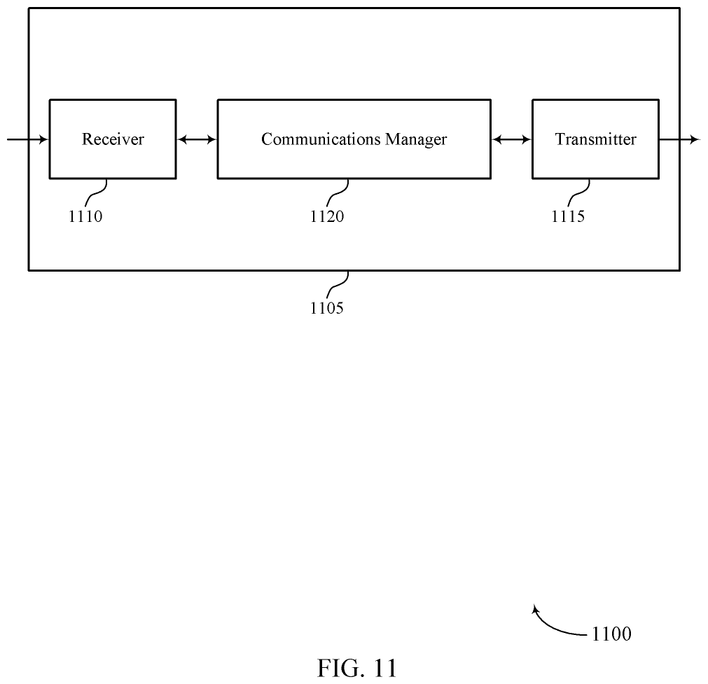

FIG. 11 illustrates a block diagram 1100 of a device 1105 that supports independent mapping of common and private transport blocks for rate splitting in accordance with one or more aspects of the present disclosure. The device 1105 may be an example of aspects of a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to independent mapping of common and private transport blocks for rate splitting). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to independent mapping of common and private transport blocks for rate splitting). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of independent mapping of common and private transport blocks for rate splitting as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a UE in accordance with examples as disclosed herein. For example, the communications manager 1120 may be configured as or otherwise support a means for receiving, from a network entity, a message including a common portion and a private portion. The communications manager 1120 may be configured as or otherwise support a means for performing a first mapping operation to obtain the common portion based on a first mapping between one or more first PRBs and the common portion. The communications manager 1120 may be configured as or otherwise support a means for performing a second mapping operation that is independent of the first mapping operation, the second mapping operation to obtain the private portion based on a second mapping between one or more second PRBs and the private portion.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for efficient utilization of resources for rate splitting, which may reduce processing, reduce power consumption, and increase efficiency in utilization of communication resources.

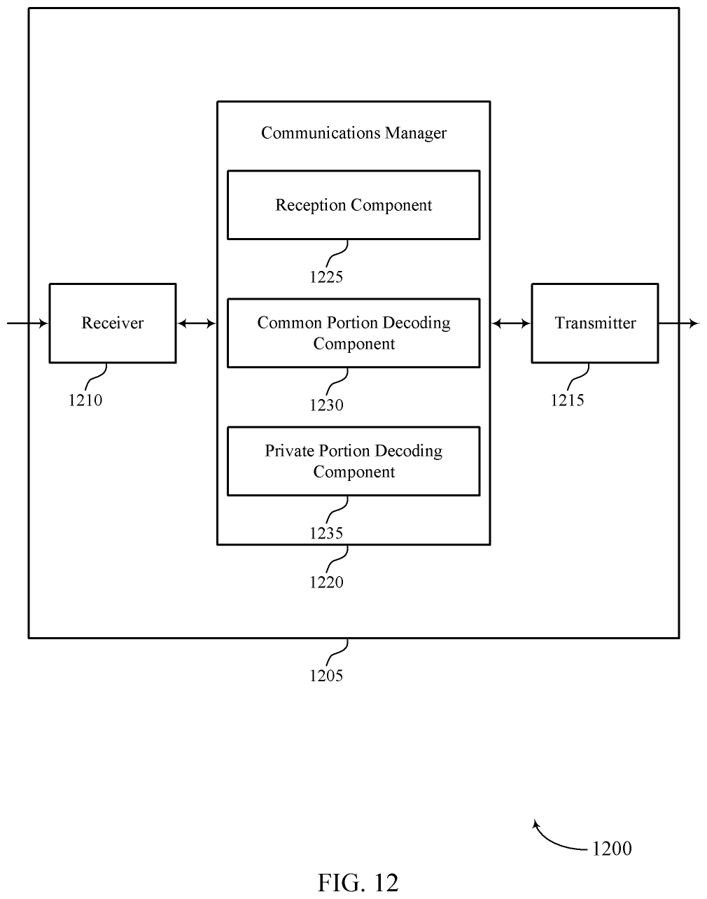

FIG. 12 illustrates a block diagram 1200 of a device 1205 that supports independent mapping of common and private transport blocks for rate splitting in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to independent mapping of common and private transport blocks for rate splitting). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to independent mapping of common and private transport blocks for rate splitting). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of independent mapping of common and private transport blocks for rate splitting as described herein. For example, the communications manager 1220 may include a reception component 1225, a common portion decoding component 1230, a private portion decoding component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a UE in accordance with examples as disclosed herein. The reception component 1225 may be configured as or otherwise support a means for receiving, from a network entity, a message including a common portion and a private portion. The common portion decoding component 1230 may be configured as or otherwise support a means for performing a first mapping operation to obtain the common portion based on a first mapping between one or more first PRBs and the common portion. The private portion decoding component 1235 may be configured as or otherwise support a means for performing a second mapping operation that is independent of the first mapping operation, the second mapping operation to obtain the private portion based on a second mapping between one or more second PRBs and the private portion.

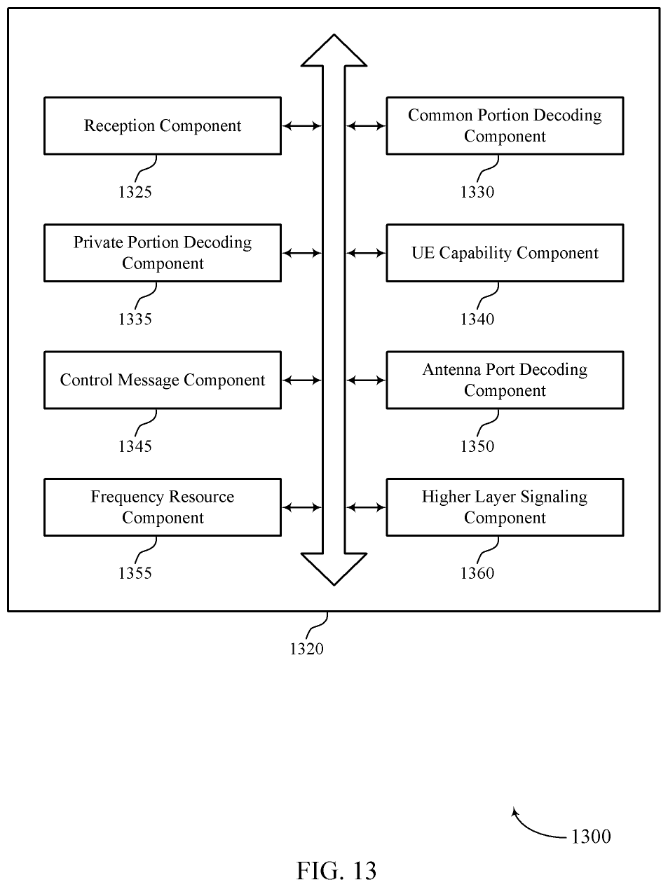

FIG. 13 illustrates a block diagram 1300 of a communications manager 1320 that supports independent mapping of common and private transport blocks for rate splitting in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of independent mapping of common and private transport blocks for rate splitting as described herein. For example, the communications manager 1320 may include a reception component 1325, a common portion decoding component 1330, a private portion decoding component 1335, a UE capability component 1340, a control message component 1345, an antenna port decoding component 1350, a frequency resource component 1355, a higher layer signaling component 1360, or any combination thereof. Each of these components may communicate, directly or indirectly, with one another (e.g., via one or more buses).

The communications manager 1320 may support wireless communication at a UE in accordance with examples as disclosed herein. The reception component 1325 may be configured as or otherwise support a means for receiving, from a network entity, a message including a common portion and a private portion. The common portion decoding component 1330 may be configured as or otherwise support a means for performing a first mapping operation to obtain the common portion based on a first mapping between one or more first PRBs and the common portion. The private portion decoding component 1335 may be configured as or otherwise support a means for performing a second mapping operation that is independent of the first mapping operation, the second mapping operation to obtain the private portion based on a second mapping between one or more second PRBs and the private portion.

In some examples, the UE capability component 1340 may be configured as or otherwise support a means for transmitting, to the network entity, signaling indicating that the UE is capable of decoding a second message including a first portion that is mapped independently of a second portion, where receiving the message is based on transmitting the signaling.

In some examples, the UE capability component 1340 may be configured as or otherwise support a means for transmitting, to the network entity, signaling indicating whether the UE is capable of decoding a second message including a first portion that is mapped according to an interleaved mapping operation and a second portion that is mapped according to a non-interleaved mapping operation, where receiving the message is based on transmitting the signaling.

In some examples, the UE capability component 1340 may be configured as or otherwise support a means for transmitting, to the network entity, signaling indicating whether the UE is capable of decoding a second message that is mapped to a set of frequency resources by interleaving the second message within PRBs that span the set of frequency resources, where the set of frequency resources are allocated for the second message and span a portion of a downlink bandwidth part, and where receiving the message is based on transmitting the signaling.

In some examples, the first mapping includes a non-interleaved mapping of the common portion to the one or more first PRBs. In some examples, the second mapping includes an interleaved mapping of the private portion to the one or more second PRBs.

In some examples, the control message component 1345 may be configured as or otherwise support a means for receiving, from the network entity, a control message including an indicator of a set of frequency resources for the message, where the one or more first PRBs and the one or more second PRBs each span the set of frequency resources, and where performing the first mapping operation and the second mapping operation is based on receiving the control message.

In some examples, the set of frequency resources span a portion of frequency resources within a downlink bandwidth part. In some examples, the second mapping includes an interleaved mapping within the set of frequency resources of the private portion to the one or more second PRBs.

In some examples, the control message component 1345 may be configured as or otherwise support a means for receiving, from the network entity, a control message including a first indication of whether the first mapping includes interleaving and a second indication of whether the second mapping includes interleaving, where performing the first mapping operation and the second mapping operation is based on receiving the control message.

In some examples, the higher layer signaling component 1360 may be configured as or otherwise support a means for receiving, from the network entity, signaling indicating that the control message includes the first indication and the second indication, where receiving the control message is based on receiving the signaling.

In some examples, the reception component 1325 may be configured as or otherwise support a means for receiving, from the network entity, signaling indicating that mapping operations performed on common portions of messages include non-interleaved mapping. In some examples, the control message component 1345 may be configured as or otherwise support a means for receiving, from the network entity and based on receiving the signaling, a control message including an indication of whether the second mapping includes interleaving. In some examples, the common portion decoding component 1330 may be configured as or otherwise support a means for the first mapping includes a non-interleaved mapping of the common portion to the one or more first PRBs. In some examples, the private portion decoding component 1335 may be configured as or otherwise support a means for the second mapping includes a non-interleaved mapping or an interleaved mapping in accordance with the indication of whether the second mapping operation includes interleaving.

In some examples, the first mapping operation is further based on a third mapping between one or more first layers and the common portion. In some examples, the second mapping operation is further based on a fourth mapping that is independent of the third mapping, the fourth mapping between one or more second layers and the private portion.

In some examples, the antenna port decoding component 1350 may be configured as or otherwise support a means for mapping, based on receiving the message, the message from one or more antenna ports at the UE, where performing the first mapping operation and the second mapping operation is based on mapping the message from the one or more antenna ports.

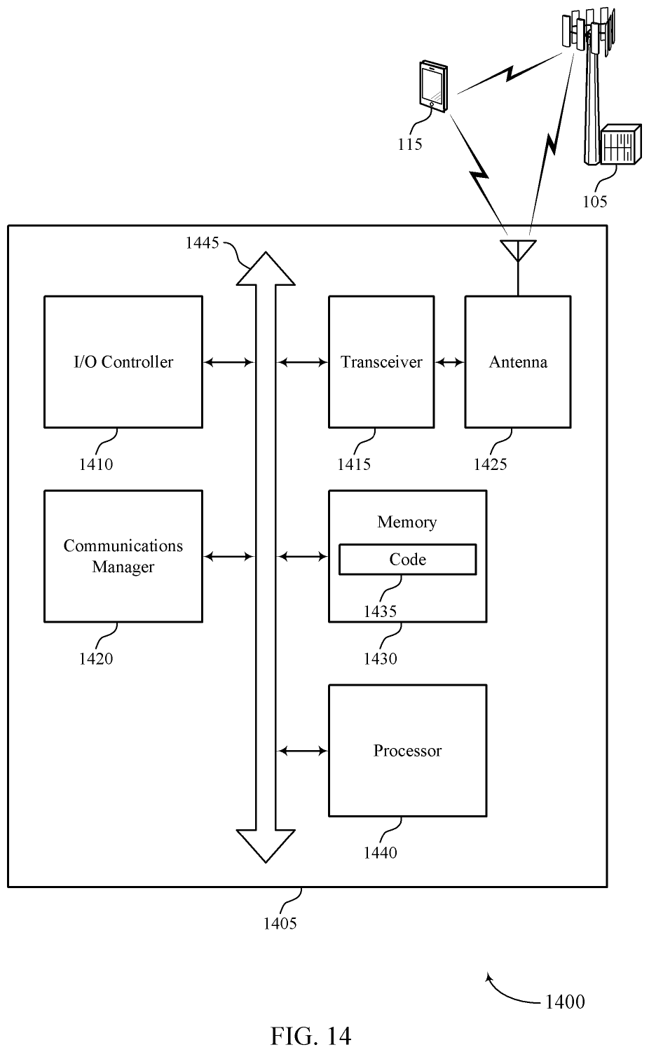

FIG. 14 illustrates a diagram of a system 1400 including a device 1405 that supports independent mapping of common and private transport blocks for rate splitting in accordance with one or more aspects of the present disclosure. The device 1405 may be an example of or include the components of a device 1105, a device 1205, or a UE 115 as described herein. The device 1405 may communicate (e.g., wirelessly) with one or more network entities 105, one or more UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting independent mapping of common and private transport blocks for rate splitting). For example, the device 1405 or a component of the device 1405 may include a processor 1440 and memory 1430 coupled with or to the processor 1440, the processor 1440 and memory 1430 configured to perform various functions described herein.

The communications manager 1420 may support wireless communication at a UE in accordance with examples as disclosed herein. For example, the communications manager 1420 may be configured as or otherwise support a means for receiving, from a network entity, a message including a common portion and a private portion. The communications manager 1420 may be configured as or otherwise support a means for performing a first mapping operation to obtain the common portion based on a first mapping between one or more first PRBs and the common portion. The communications manager 1420 may be configured as or otherwise support a means for performing a second mapping operation that is independent of the first mapping operation, the second mapping operation to obtain the private portion based on a second mapping between one or more second PRBs and the private portion.

By including or configuring the communications manager 1420 in accordance with examples as described herein, the device 1405 may support techniques for may support techniques for efficient utilization of resources for rate splitting, which may improve communication reliability, reduce latency, and increase efficiency in utilization of communication resources.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of independent mapping of common and private transport blocks for rate splitting as described herein, or the processor 1440 and the memory 1430 may be otherwise configured to perform or support such operations.

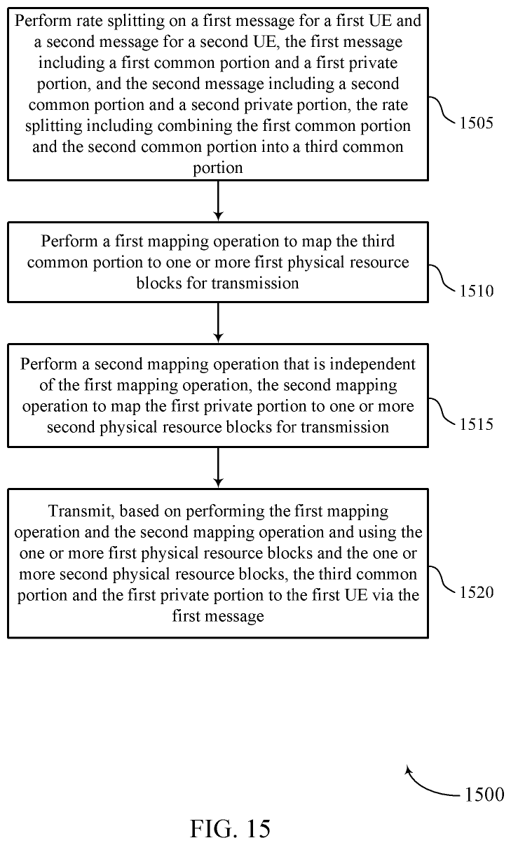

FIG. 15 illustrates a flowchart illustrating a method 1500 that supports independent mapping of common and private transport blocks for rate splitting in accordance with one or more aspects of the present disclosure. The operations of the method 1500 may be implemented by a network entity or its components as described herein. For example, the operations of the method 1500 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1505, the method may include performing rate splitting on a first message for a first UE and a second message for a second UE, the first message including a first common portion and a first private portion, and the second message including a second common portion and a second private portion, the rate splitting including combining the first common portion and the second common portion into a third common portion. The operations of 1505 may be performed in accordance with examples as disclosed herein. In some examples, aspects of the operations of 1505 may be performed by a rate splitting component 925 as described with reference to FIG. 9.

At 1510, the method may include performing a first mapping operation to map the third common portion to one or more first PRBs for transmission. The operations of 1510 may be performed in accordance with examples as disclosed herein. In some examples, aspects of the operations of 1510 may be performed by a common portion mapping component 930 as described with reference to FIG. 9.

At 1515, the method may include performing a second mapping operation that is independent of the first mapping operation, the second mapping operation to map the first private portion to one or more second PRBs for transmission. The operations of 1515 may be performed in accordance with examples as disclosed herein. In some examples, aspects of the operations of 1515 may be performed by a private portion mapping component 935 as described with reference to FIG. 9.

At 1520, the method may include transmitting, based on performing the first mapping operation and the second mapping operation and using the one or more first PRBs and the one or more second PRBs, the third common portion and the first private portion to the first UE via the first message. The operations of 1520 may be performed in accordance with examples as disclosed herein. In some examples, aspects of the operations of 1520 may be performed by a communications component 940 as described with reference to FIG. 9.

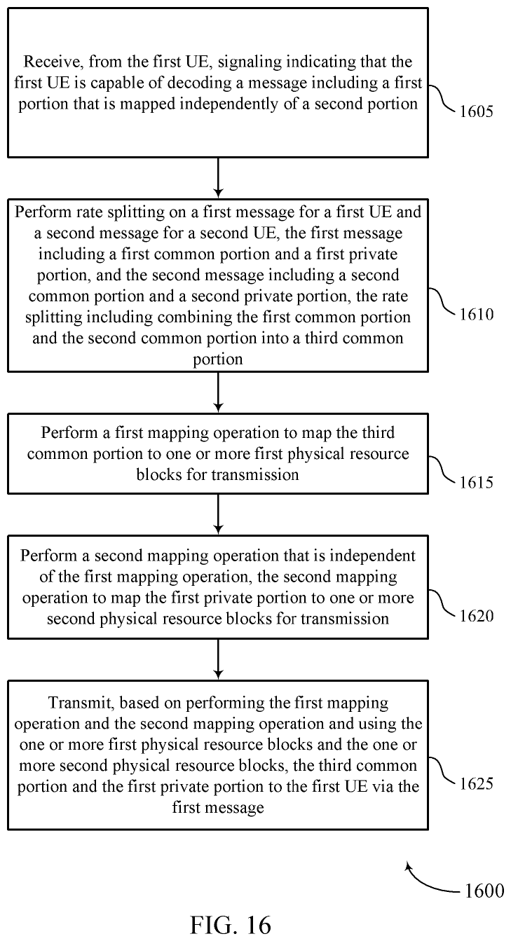

FIG. 16 illustrates a flowchart illustrating a method 1600 that supports independent mapping of common and private transport blocks for rate splitting in accordance with one or more aspects of the present disclosure. The operations of the method 1600 may be implemented by a network entity or its components as described herein. For example, the operations of the method 1600 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1605, the method may include receiving, from the first UE, signaling indicating that the first UE is capable of decoding a message including a first portion that is mapped independently of a second portion. The operations of 1605 may be performed in accordance with examples as disclosed herein. In some examples, aspects of the operations of 1605 may be performed by a UE capability component 945 as described with reference to FIG. 9.

At 1610, the method may include performing rate splitting on a first message for a first UE and a second message for a second UE, the first message including a first common portion and a first private portion, and the second message including a second common portion and a second private portion, the rate splitting including combining the first common portion and the second common portion into a third common portion. The operations of 1610 may be performed in accordance with examples as disclosed herein. In some examples, aspects of the operations of 1610 may be performed by a rate splitting component 925 as described with reference to FIG. 9.

At 1615, the method may include performing a first mapping operation to map the third common portion to one or more first PRBs for transmission. The operations of 1615 may be performed in accordance with examples as disclosed herein. In some examples, aspects of the operations of 1615 may be performed by a common portion mapping component 930 as described with reference to FIG. 9.

At 1620, the method may include performing a second mapping operation that is independent of the first mapping operation, the second mapping operation to map the first private portion to one or more second PRBs for transmission. The operations of 1620 may be performed in accordance with examples as disclosed herein. In some examples, aspects of the operations of 1620 may be performed by a private portion mapping component 935 as described with reference to FIG. 9.

At 1625, the method may include transmitting, based on performing the first mapping operation and the second mapping operation and using the one or more first PRBs and the one or more second PRBs, the third common portion and the first private portion to the first UE via the first message. The operations of 1625 may be performed in accordance with examples as disclosed herein. In some examples, aspects of the operations of 1625 may be performed by a communications component 940 as described with reference to FIG. 9.

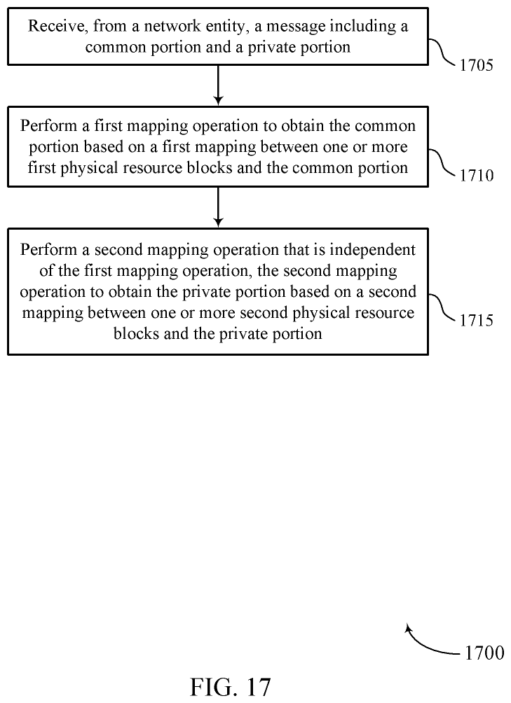

FIG. 17 illustrates a flowchart illustrating a method 1700 that supports independent mapping of common and private transport blocks for rate splitting in accordance with one or more aspects of the present disclosure. The operations of the method 1700 may be implemented by a UE or its components as described herein. For example, the operations of the method 1700 may be performed by a UE 115 as described with reference to FIGS. 1 through 6 and 11 through 14. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, a message including a common portion and a private portion. The operations of 1705 may be performed in accordance with examples as disclosed herein. In some examples, aspects of the operations of 1705 may be performed by a reception component 1325 as described with reference to FIG. 13.

At 1710, the method may include performing a first mapping operation to obtain the common portion based on a first mapping between one or more first PRBs and the common portion. The operations of 1710 may be performed in accordance with examples as disclosed herein. In some examples, aspects of the operations of 1710 may be performed by a common portion decoding component 1330 as described with reference to FIG. 13.

At 1715, the method may include performing a second mapping operation that is independent of the first mapping operation, the second mapping operation to obtain the private portion based on a second mapping between one or more second PRBs and the private portion. The operations of 1715 may be performed in accordance with examples as disclosed herein. In some examples, aspects of the operations of 1715 may be performed by a private portion decoding component 1335 as described with reference to FIG. 13.

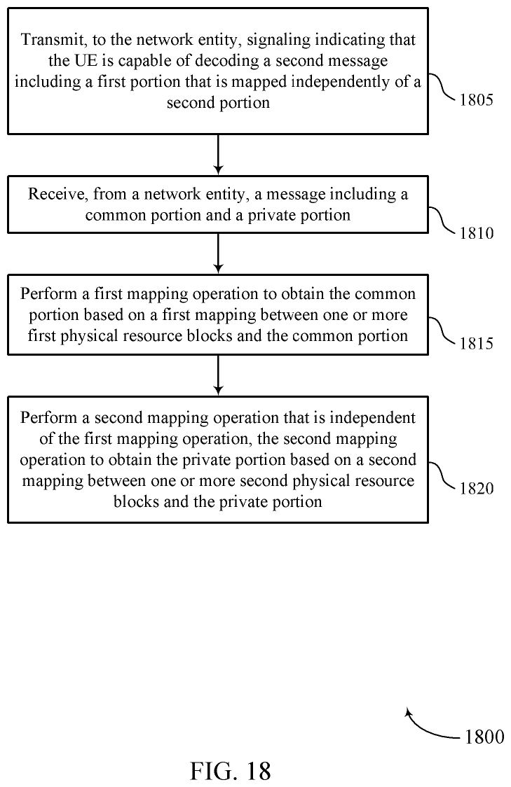

FIG. 18 illustrates a flowchart illustrating a method 1800 that supports independent mapping of common and private transport blocks for rate splitting in accordance with one or more aspects of the present disclosure. The operations of the method 1800 may be implemented by a UE or its components as described herein. For example, the operations of the method 1800 may be performed by a UE 115 as described with reference to FIGS. 1 through 6 and 11 through 14. In some examples, a UE may execute a set of instructions to control the functional elements of the UE to perform the described functions. Additionally, or alternatively, the UE may perform aspects of the described functions using special-purpose hardware.

At 1805, the method may include transmitting, to the network entity, signaling indicating that the UE is capable of decoding a second message including a first portion that is mapped independently of a second portion. The operations of 1805 may be performed in accordance with examples as disclosed herein. In some examples, aspects of the operations of 1805 may be performed by a UE capability component 1340 as described with reference to FIG. 13.

At 1810, the method may include receiving, from a network entity, a message including a common portion and a private portion. The operations of 1810 may be performed in accordance with examples as disclosed herein. In some examples, aspects of the operations of 1810 may be performed by a reception component 1325 as described with reference to FIG. 13.

At 1815, the method may include performing a first mapping operation to obtain the common portion based on a first mapping between one or more first PRBs and the common portion. The operations of 1815 may be performed in accordance with examples as disclosed herein. In some examples, aspects of the operations of 1815 may be performed by a common portion decoding component 1330 as described with reference to FIG. 13.

At 1820, the method may include performing a second mapping operation that is independent of the first mapping operation, the second mapping operation to obtain the private portion based on a second mapping between one or more second PRBs and the private portion. The operations of 1820 may be performed in accordance with examples as disclosed herein. In some examples, aspects of the operations of 1820 may be performed by a private portion decoding component 1335 as described with reference to FIG. 13.

The following provides an overview of aspects of the present disclosure:

Aspect 1: A method for wireless communication at a network entity, the method comprising: performing rate splitting on a first message for a first UE and a second message for a second UE, the first message comprising a first common portion and a first private portion, and the second message comprising a second common portion and a second private portion, the rate splitting comprising combining the first common portion and the second common portion into a third common portion; performing a first mapping operation to map the third common portion to one or more first PRBs for transmission; performing a second mapping operation that is independent of the first mapping operation, the second mapping operation to map the first private portion to one or more second PRBs for transmission; and transmitting, based at least in part on performing the first mapping operation and the second mapping operation and using the one or more first PRBs and the one or more second PRBs, the third common portion and the first private portion to the first UE via the first message.

Aspect 2: The method of aspect 1, further comprising: receiving, from the first UE, signaling indicating that the first UE is capable of decoding a message comprising a first portion that is mapped independently of a second portion, wherein performing the rate splitting on the first message and the second message is based at least in part on receiving the signaling.

Aspect 3: The method of any of aspects 1 through 2, further comprising: receiving, from the first UE, signaling indicating whether the first UE is capable of decoding a message comprising a first portion that is mapped according to an interleaved mapping operation and a second portion that is mapped according to a non-interleaved mapping operation, wherein performing the first mapping operation and the second mapping operation is based at least in part on receiving the signaling from the UE.

Aspect 4: The method of any of aspects 1 through 3, further comprising: receiving, from the first UE, signaling indicating whether the first UE is capable of decoding a message that is mapped to a set of frequency resources by interleaving the message within PRBs that span the set of frequency resources, wherein the set of frequency resources are allocated for the message and span a portion of a downlink bandwidth part, and wherein performing the first mapping operation and the second mapping operation is based at least in part on receiving the signaling from the UE.

Aspect 5: The method of any of aspects 1 through 4, further comprising: performing the first mapping operation comprises mapping the third common portion to the one or more first PRBs according to a non-interleaved mapping; and performing the second mapping operation comprises mapping the first private portion to the one or more second PRBs according to an interleaved mapping.

Aspect 6: The method of any of aspects 1 through 5, further comprising: transmitting, to the first UE, a control message comprising an indicator of a set of frequency resources for a transmission of the first message, wherein the one or more first PRBs and the one or more second PRBs each span the set of frequency resources, and wherein performing the first mapping operation and the second mapping operation is based at least in part on transmitting the control message.

Aspect 7: The method of aspect 6, wherein the set of frequency resources span a portion of frequency resources within a downlink bandwidth part; and performing the second mapping operation comprises interleaving the first private portion within the set of frequency resources to map the first private portion to the one or more second PRBs.

Aspect 8: The method of any of aspects 6 through 7, further comprising: transmitting, to the second UE, a second control message comprising a second indicator of the set of frequency resources for a transmission of the second message, wherein the set of frequency resources span a downlink bandwidth part, and wherein performing the first mapping operation and the second mapping operation is based at least in part on transmitting the second control message.

Aspect 9: The method of any of aspects 1 through 8, further comprising: transmitting, to the first UE, a control message comprising a first indication of whether the first mapping operation comprises interleaving and a second indication of whether the second mapping operation comprises interleaving, wherein performing the first mapping operation and the second mapping operation is based at least in part on transmitting the control message.

Aspect 10: The method of aspect 9, further comprising: transmitting, to the first UE, signaling indicating that the control message comprises the first indication and the second indication, wherein transmitting the control message is based at least in part on transmitting the signaling.

Aspect 11: The method of any of aspects 1 through 10, further comprising: transmitting, to the first UE, signaling indicating that mapping operations performed on common portions of messages comprise non-interleaved mapping; and transmitting, to the first UE and based at least in part on transmitting the signaling, a control message comprising an indication of whether the second mapping operation comprises interleaving, wherein: performing the first mapping operation comprises mapping the third common portion to the one or more first PRBs according to a non-interleaved mapping, and performing the second mapping operation comprises mapping the first private portion according to a non-interleaved mapping or an interleaved mapping in accordance with the indication of whether the second mapping operation comprises interleaving.

Aspect 12: The method of any of aspects 1 through 11, wherein performing the first mapping operation further comprises mapping the third common portion to one or more first layers for transmission; and performing the second mapping operation further comprises mapping the first private portion to one or more second layers for transmission independently of mapping the third common portion to the one or more first layers for transmission.

Aspect 13: The method of any of aspects 1 through 12, further comprising: mapping, based at least in part on performing the first mapping operation and the second mapping operation, the third common portion and the first private portion of the first message to one or more antenna ports at the network entity, wherein transmitting the third common portion and the first private portion is based at least in part on mapping the third common portion and the first private portion to the one or more antenna ports.

Aspect 14: The method of any of aspects 1 through 13, further comprising: performing a third mapping operation that is independent of the first mapping operation and the second mapping operation, the third mapping operation to map the second private portion to one or more third PRBs for transmission; and transmitting, based at least in part on performing the first mapping operation and the third mapping operation and using the one or more first PRBs and the one or more third PRBs, the third common portion and the second private portion to the second UE via the second message.

Aspect 15: A method for wireless communication at a UE, the method comprising: receiving, from a network entity, a message comprising a common portion and a private portion; performing a first mapping operation to obtain the common portion based at least in part on a first mapping between one or more first PRBs and the common portion; and performing a second mapping operation that is independent of the first mapping operation, the second mapping operation to obtain the private portion based at least in part on a second mapping between one or more second PRBs and the private portion.

Aspect 16: The method of aspect 15, further comprising: transmitting, to the network entity, signaling indicating that the UE is capable of decoding a second message comprising a first portion that is mapped independently of a second portion, wherein receiving the message is based at least in part on transmitting the signaling.

Aspect 17: The method of any of aspects 15 through 16, further comprising: transmitting, to the network entity, signaling indicating whether the UE is capable of decoding a second message comprising a first portion that is mapped according to an interleaved mapping operation and a second portion that is mapped according to a non-interleaved mapping operation, wherein receiving the message is based at least in part on transmitting the signaling.

Aspect 18: The method of any of aspects 15 through 17, further comprising: transmitting, to the network entity, signaling indicating whether the UE is capable of decoding a second message that is mapped to a set of frequency resources by interleaving the second message within PRBs that span the set of frequency resources, wherein the set of frequency resources are allocated for the second message and span a portion of a downlink bandwidth part, and wherein receiving the message is based at least in part on transmitting the signaling.

Aspect 19: The method of any of aspects 15 through 18, wherein the first mapping comprises a non-interleaved mapping of the common portion to the one or more first PRBs; and the second mapping comprises an interleaved mapping of the private portion to the one or more second PRBs.

Aspect 20: The method of any of aspects 15 through 19, further comprising: receiving, from the network entity, a control message comprising an indicator of a set of frequency resources for the message, wherein the one or more first PRBs and the one or more second PRBs each span the set of frequency resources, and wherein performing the first mapping operation and the second mapping operation is based at least in part on receiving the control message.

Aspect 21: The method of aspect 20, wherein the set of frequency resources span a portion of frequency resources within a downlink bandwidth part; and the second mapping comprises an interleaved mapping within the set of frequency resources of the private portion to the one or more second PRBs.

Aspect 22: The method of any of aspects 15 through 21, further comprising: receiving, from the network entity, a control message comprising a first indication of whether the first mapping comprises interleaving and a second indication of whether the second mapping comprises interleaving, wherein performing the first mapping operation and the second mapping operation is based at least in part on receiving the control message.

Aspect 23: The method of aspect 22, further comprising: receiving, from the network entity, signaling indicating that the control message comprises the first indication and the second indication, wherein receiving the control message is based at least in part on receiving the signaling.

Aspect 24: The method of any of aspects 15 through 23, further comprising: receiving, from the network entity, signaling indicating that mapping operations performed on common portions of messages comprise non-interleaved mapping; and receiving, from the network entity and based at least in part on receiving the signaling, a control message comprising an indication of whether the second mapping comprises interleaving, wherein: the first mapping comprises a non-interleaved mapping of the common portion to the one or more first PRBs, and the second mapping comprises a non-interleaved mapping or an interleaved mapping in accordance with the indication of whether the second mapping operation comprises interleaving.

Aspect 25: The method of any of aspects 15 through 24, wherein the first mapping operation is further based at least in part on a third mapping between one or more first layers and the common portion; and the second mapping operation is further based at least in part on a fourth mapping that is independent of the third mapping, the fourth mapping between one or more second layers and the private portion.

Aspect 26: The method of any of aspects 15 through 25, further comprising: mapping, based at least in part on receiving the message, the message from one or more antenna ports at the UE, wherein performing the first mapping operation and the second mapping operation is based at least in part on mapping the message from the one or more antenna ports.

Aspect 27: An apparatus for wireless communication at a network entity, comprising a processor; memory coupled with the processor; and instructions stored in the memory and executable by the processor to cause the apparatus to perform a method of any of aspects 1 through 14.

Aspect 28: An apparatus for wireless communication at a network entity, comprising at least one means for performing a method of any of aspects 1 through 14.

Aspect 29: A non-transitory computer-readable medium storing code for wireless communication at a network entity, the code comprising instructions executable by a processor to perform a method of any of aspects 1 through 14.

Aspect 30: An apparatus for wireless communication at a UE, comprising a processor; memory coupled with the processor; and instructions stored in the memory and executable by the processor to cause the apparatus to perform a method of any of aspects 15 through 26.

Aspect 31: An apparatus for wireless communication at a UE, comprising at least one means for performing a method of any of aspects 15 through 26.

Aspect 32: A non-transitory computer-readable medium storing code for wireless communication at a UE, the code comprising instructions executable by a processor to perform a method of any of aspects 15 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a network entity, comprising:
a processor;
memory coupled with the processor; and
instructions stored in the memory and executable by the processor to cause the apparatus to:
perform rate splitting on a first message for a first user equipment (UE) and a second message for a second UE, the first message comprising a first common portion and a first private portion, and the second message comprising a second common portion and a second private portion, the rate splitting comprising combining the first common portion and the second common portion into a third common portion;
perform a first mapping operation to map the third common portion to one or more first physical resource blocks for transmission;
perform a second mapping operation that is independent of the first mapping operation, the second mapping operation to map the first private portion to one or more second physical resource blocks for transmission; and
transmit, based at least in part on performing the first mapping operation and the second mapping operation and using the one or more first physical resource blocks and the one or more second physical resource blocks, the third common portion and the first private portion to the first UE via the first message.

2. The apparatus of claim 1, wherein the instructions are further executable by the processor to cause the apparatus to:
receive, from the first UE, signaling indicating that the first UE is capable of decoding a message comprising a first portion that is mapped independently of a second portion, wherein performing the rate splitting on the first message and the second message is based at least in part on receiving the signaling.

3. The apparatus of claim 1, wherein the instructions are further executable by the processor to cause the apparatus to:
receive, from the first UE, signaling indicating whether the first UE is capable of decoding a message comprising a first portion that is mapped according to an interleaved mapping operation and a second portion that is mapped according to a non-interleaved mapping operation, wherein performing the first mapping operation and the second mapping operation is based at least in part on receiving the signaling from the UE.

4. The apparatus of claim 1, wherein the instructions are further executable by the processor to cause the apparatus to:
receive, from the first UE, signaling indicating whether the first UE is capable of decoding a message that is mapped to a set of frequency resources by interleaving the message within physical resource blocks that span the set of frequency resources, wherein the set of frequency resources are allocated for the message and span a portion of a downlink bandwidth part, and wherein performing the first mapping operation and the second mapping operation is based at least in part on receiving the signaling from the UE.

5. The apparatus of claim 1, wherein the instructions are further executable by the processor to cause the apparatus to:
perform the first mapping operation comprises mapping the third common portion to the one or more first physical resource blocks according to a non-interleaved mapping; and
perform the second mapping operation comprises mapping the first private portion to the one or more second physical resource blocks according to an interleaved mapping.

6. The apparatus of claim 1, wherein the instructions are further executable by the processor to cause the apparatus to:
transmit, to the first UE, a control message comprising an indicator of a set of frequency resources for a transmission of the first message, wherein the one or more first physical resource blocks and the one or more second physical resource blocks each span the set of frequency resources, and wherein performing the first mapping operation and the second mapping operation is based at least in part on transmitting the control message.

7. (canceled)

8. The apparatus of claim 6, wherein the instructions are further executable by the processor to cause the apparatus to:
transmit, to the second UE, a second control message comprising a second indicator of the set of frequency resources for a transmission of the second message, wherein the set of frequency resources span a downlink bandwidth part, and wherein performing the first mapping operation and the second mapping operation is based at least in part on transmitting the second control message.

9. The apparatus of claim 1, wherein the instructions are further executable by the processor to cause the apparatus to:
transmit, to the first UE, a control message comprising a first indication of whether the first mapping operation comprises interleaving and a second indication of whether the second mapping operation comprises interleaving, wherein performing the first mapping operation and the second mapping operation is based at least in part on transmitting the control message.

10. (canceled)

11. (canceled)

12. The apparatus of claim 1, wherein:
performing the first mapping operation further comprises mapping the third common portion to one or more first layers for transmission; and
performing the second mapping operation further comprises mapping the first private portion to one or more second layers for transmission independently of mapping the third common portion to the one or more first layers for transmission.

13. (canceled)

14. (canceled)

15. An apparatus for wireless communication at a user equipment (UE), comprising:
a processor;
memory coupled with the processor; and
instructions stored in the memory and executable by the processor to cause the apparatus to:
receive, from a network entity, a message comprising a common portion and a private portion;
perform a first mapping operation to obtain the common portion based at least in part on a first mapping between one or more first physical resource blocks and the common portion; and
perform a second mapping operation that is independent of the first mapping operation, the second mapping operation to obtain the private portion based at least in part on a second mapping between one or more second physical resource blocks and the private portion.

16. The apparatus of claim 15, wherein the instructions are further executable by the processor to cause the apparatus to:
transmit, to the network entity, signaling indicating that the UE is capable of decoding a second message comprising a first portion that is mapped independently of a second portion, wherein receiving the message is based at least in part on transmitting the signaling.

17. The apparatus of claim 15, wherein the instructions are further executable by the processor to cause the apparatus to:
transmit, to the network entity, signaling indicating whether the UE is capable of decoding a second message comprising a first portion that is mapped according to an interleaved mapping operation and a second portion that is mapped according to a non-interleaved mapping operation, wherein receiving the message is based at least in part on transmitting the signaling.

18. The apparatus of claim 15, wherein the instructions are further executable by the processor to cause the apparatus to:
transmit, to the network entity, signaling indicating whether the UE is capable of decoding a second message that is mapped to a set of frequency resources by interleaving the second message within physical resource blocks that span the set of frequency resources, wherein the set of frequency resources are allocated for the second message and span a portion of a downlink bandwidth part, and wherein receiving the message is based at least in part on transmitting the signaling.

19. The apparatus of claim 15, wherein:
the first mapping comprises a non-interleaved mapping of the common portion to the one or more first physical resource blocks; and
the second mapping comprises an interleaved mapping of the private portion to the one or more second physical resource blocks.

20. The apparatus of claim 15, wherein the instructions are further executable by the processor to cause the apparatus to:
receive, from the network entity, a control message comprising an indicator of a set of frequency resources for the message, wherein the one or more first physical resource blocks and the one or more second physical resource blocks each span the set of frequency resources, and wherein performing the first mapping operation and the second mapping operation is based at least in part on receiving the control message.

21. (canceled)

22. The apparatus of claim 15, wherein the instructions are further executable by the processor to cause the apparatus to:
receive, from the network entity, a control message comprising a first indication of whether the first mapping comprises interleaving and a second indication of whether the second mapping comprises interleaving, wherein performing the first mapping operation and the second mapping operation is based at least in part on receiving the control message.

23. (canceled)

24. The apparatus of claim 15, wherein the instructions are further executable by the processor to cause the apparatus to:
receive, from the network entity, signaling indicating that mapping operations performed on common portions of messages comprise non-interleaved mapping; and
receive, from the network entity and based at least in part on receiving the signaling, a control message comprising an indication of whether the second mapping comprises interleaving, wherein:
the first mapping comprise a non-interleaved mapping of the common portion to the one or more first physical resource blocks, and
the second mapping comprise a non-interleaved mapping or an interleaved mapping in accordance with the indication of whether the second mapping operation comprises interleaving.

25. The apparatus of claim 15, wherein:
the first mapping operation is further based at least in part on a third mapping between one or more first layers and the common portion; and
the second mapping operation is further based at least in part on a fourth mapping that is independent of the third mapping, the fourth mapping between one or more second layers and the private portion.

26. The apparatus of claim 15, wherein the instructions are further executable by the processor to cause the apparatus to:
map, based at least in part on receiving the message, the message from one or more antenna ports at the UE, wherein performing the first mapping operation and the second mapping operation is based at least in part on mapping the message from the one or more antenna ports.

27-29. (canceled)

30. A method for wireless communication at a user equipment (UE), the method comprising:
receiving, from a network entity, a message comprising a common portion and a private portion;
performing a first mapping operation to obtain the common portion based at least in part on a first mapping between one or more first physical resource blocks and the common portion; and
performing a second mapping operation that is independent of the first mapping operation, the second mapping operation to obtain the private portion based at least in part on a second mapping between one or more second physical resource blocks and the private portion.
